(19) United States
(12) Patent Application Publication
(10) Pub. No.: US 2015/0175147 A1
(43) Pub. Date: Jun. 25, 2015

(54) HYBRID VEHICLE

(71) Applicant: Toyota Jidosha Kabushiki Kaisha, Toyota-shi (JP)

(72) Inventors: Ryuta Teraya, Susono-shi (JP); Toshikazu Kato, Toyota-shi (JP); Yoshikazu Asami, Susono-shi (JP)

(21) Appl. No.: 14/573,367

(22) Filed: Dec. 17, 2014

(30) Foreign Application Priority Data
Dec. 19, 2013 (JP) 2013-262674

(51) Int. Cl. B60W 10/06; B60W 20/00; B60W 10/08

(52) U.S. Cl. CPC B60W 10/06; B60W 10/08; B60W 20/10; Y10S 903/902

(57) ABSTRACT

An engine has a variable valve actuation device for controlling an actuation characteristic of an intake valve that is an amount of lifting the intake valve and/or a working angle on the intake valve. When the intake valve having the actuation characteristic (or lifted in an amount and/or worked by a working angle) controlled by the variable valve actuation device has the actuation characteristic (or the amount and/or the angle) fixed, intermittently operating the engine is not unconditionally stopped, and when a power storage device is not limited in chargeability and dischargeability and a cranking torque is ensured to ensure that the engine is startable, intermittently stopping the engine is permitted.

This nonprovisional application is based on Japanese Patent Application No. 2013-262674 filed on Dec. 19, 2013, with the Japan Patent Office, the entire contents of which are hereby incorporated by reference.

### BACKGROUND OF THE INVENTION

1. Field of the Invention

The present invention relates to a hybrid vehicle, and more specifically to a hybrid vehicle including an internal combustion engine having a variable valve actuation device for varying an actuation characteristic of an intake valve.

2. Description of the Background Art

An internal combustion engine is known to have a variable valve actuation device capable of varying an actuation characteristic of an intake valve. Furthermore, one such variable valve actuation device is known to allow an intake valve to be lifted in a varying amount and/or worked by a varying working angle.

For example, Japanese Patent Laying-Open No. 2009-202662 discloses a hybrid vehicle having mounted therein an internal combustion engine having a variable valve actuation device allowing an intake valve to be lifted in an amount varying in magnitude and to be worked by a working angle (or an operation angle) varying in magnitude. Japanese Patent Laying-Open No. 2009-202662 discloses that when the hybrid vehicle has the variable valve actuation device diagnosed to have failed, and the vehicle is also travelling and stopped, the internal combustion engine is prohibited from stopping.

### SUMMARY OF THE INVENTION

Generally, a hybrid vehicle allows vehicular speed, a required driving force requested by the driver (or an amount by which the accelerator is operated), and other vehicular conditions to be considered to allow the internal combustion engine to be operated and stopped as automatically controlled, i.e., to be intermittently operated, for better fuel economy.

If stopping the internal combustion engine is prohibited whenever the variable valve actuation device has failed or the like and the intake valve accordingly has an actuation characteristic fixed (i.e., is lifted in a fixed amount and/or worked by a fixed working angle), as described in Japanese Patent Laying-Open No. 2009-202662, however, the internal combustion engine is prevented from intermittently stopping, which may result in impaired fuel economy. On the other hand, when the intake valve has the actuation characteristic fixed, intermittently stopping the internal combustion engine under some conditions may impede subsequently restarting the engine.

A major advantage of the present invention lies in that when a vehicle having an internal combustion engine with an intake valve lifted in an amount and/or worked by a working angle, as controlled by a variable valve actuation device, has the amount and/or the angle fixed, a situation in which when the internal combustion engine is intermittently stopped the engine can no longer subsequently restart can be avoided, while an opportunity to intermittently stop the engine is appropriately ensured to allow the vehicle to achieve better fuel economy.

The present invention in one aspect provides a hybrid vehicle comprising: an internal combustion engine having a variable valve actuation device for varying an actuation characteristic of an intake valve, the actuation characteristic being an amount of lifting the intake valve and/or a working angle on the intake valve; a detector; a rotating electric machine configured to be capable of starting the internal combustion engine; a power storage device for storing electric power therein for driving the rotating electric machine; and a control device configured to receive an output of the detector and also control the internal combustion engine. The detector is configured to detect the actuation characteristic controlled by the variable valve actuation device. When the detector detects that the actuation characteristic is fixed, the control device permits intermittently stopping the internal combustion engine, based on a state of the power storage device associated with a cranking torque that the rotating electric machine can output.

When the present hybrid vehicle has the variable valve actuation device having failed or is at a low temperature and thus has increased friction or the like, and accordingly the intake valve having an actuation characteristic (or lifted in an amount and/or worked by a working angle) controlled by the variable valve actuation device has the actuation characteristic (or the amount and/or the angle) fixed, intermittently stopping the internal combustion engine is nonetheless permitted if the rotating electric machine can provide a sufficient motoring torque to ensure that the internal combustion engine is startable. Thus, while a situation in which when the internal combustion engine is intermittently stopped the engine can no longer subsequently restart can be avoided, an opportunity to intermittently operate the engine is appropriately ensured. As a result, the hybrid vehicle can achieve better fuel economy than when the variable valve actuation device has failed and accordingly, intermittently stopping the internal combustion engine is unconditionally prohibited.

Preferably, when the actuation characteristic is fixed with the amount and/or the angle larger than a prescribed value, the control device permits intermittently stopping the internal combustion engine, based on the state of the power storage device. Still preferably, the control device permits intermittently stopping the internal combustion engine when the actuation characteristic is fixed with the amount and/or the angle smaller than the prescribed value.

Thus, when the intake valve has the actuation characteristic fixed such that the intake valve is lifted in a large amount and/or worked by a large working angle and accordingly, the internal combustion engine is impaired in startability, a state of the power storage device can be referred to to permit intermittently stopping the internal combustion engine. Furthermore, when the intake valve has the actuation characteristic fixed such that the intake valve is lifted in a small amount and/or worked by a small working angle and accordingly, the internal combustion engine is not impaired in startability, intermittently stopping the internal combustion engine is unconditionally permitted. Thus, while a situation in which when the internal combustion engine is intermittently stopped the engine can no longer subsequently restart can be avoided, an opportunity to intermittently operate the engine is appropriately ensured to allow the hybrid vehicle to achieve better fuel economy.

Preferably, the control device permits intermittently stopping the internal combustion engine in response to at least anyone of first to third conditions being established, the first condition being that the power storage device has an upper limit value for electric power charged having an absolute value larger than a first prescribed electric power value, the second condition being that the power storage device has an upper limit value for electric power discharged having an absolute value larger than a second prescribed electric power value, the third condition being that the power storage device is higher in temperature than a reference temperature.

Whether the rotating electric machine can ensure a motoring torque to ensure that the internal combustion engine is startable can be determined from the state of the power storage device to appropriately ensure an opportunity to intermittently operate the internal combustion engine.

Preferably, in the present hybrid vehicle, the variable valve actuation device is configured to be capable of switching the actuation characteristic of the intake valve to any one of a first characteristic, a second characteristic allowing the amount and/or the angle to be larger than when the actuation characteristic is the first characteristic, and a third characteristic allowing the amount and/or the angle to be larger than when the actuation characteristic is the second characteristic. And when the detector detects that the actuation characteristic is fixed in accordance with any one of the first to third characteristics, the control device permits intermittently stopping the internal combustion engine, based on the state of the power storage device.

When the intake valve having the actuation characteristic (or lifted in an amount and/or worked by a working angle) controlled by a variable valve actuation device in three levels has the actuation characteristic fixed in the variable valve actuation device to any one of the three levels, intermittently stopping the internal combustion engine is likewise permitted if the power storage device is not limited in performance and the rotating electric machine can provide a sufficient motoring torque to ensure that the internal combustion engine is startable. This appropriately ensures an opportunity to intermittently operate the internal combustion engine to allow the hybrid vehicle to achieve better fuel economy than when the variable valve actuation device has failed or the like and thus fixes the actuation characteristic and accordingly, intermittently stopping the internal combustion engine is unconditionally prohibited. This allows the variable valve actuation device to be simply configured and the internal combustion engine to be controlled via a parameter adapted in a reduced period of time. Furthermore, the internal combustion engine can be controlled more precisely than when the intake valve has the actuation characteristic limited to two levels as described hereinafter.

Still preferably, when the detector detects that the actuation characteristic is fixed in accordance with any one of the second and third characteristics, the control device refers to the state of the power storage device to permit intermittently stopping the internal combustion engine.

When the intake valve having the actuation characteristic (or lifted in an amount and/or worked by a working angle) controlled by a variable valve actuation device in three levels is lifted in a large amount and/or worked by a large working angle via the variable valve actuation device and the internal combustion engine is impaired in startability, and the intake valve has the actuation characteristic fixed, the state of the power storage device can be referred to to permit intermittently stopping the internal combustion engine. Thus, while a situation in which when the internal combustion engine is intermittently stopped the engine can no longer subsequently restart can be avoided, an opportunity to intermittently operate the engine is appropriately ensured to allow the hybrid vehicle to achieve better fuel economy.

Alternatively, still preferably, the control device permits intermittently stopping the internal combustion engine in response to at least any one of first to third conditions being established, the first condition being that the power storage device has an upper limit value for electric power charged having an absolute value larger than a first prescribed electric power value, the second condition being that the power storage device has an upper limit value for electric power discharged having an absolute value larger than a second prescribed electric power value, the third condition being that the power storage device is higher in temperature than a reference temperature. Still preferably, when the actuation characteristic is fixed in accordance with the second characteristic, at least one of the first prescribed electric power value, the second prescribed electric power value, and the reference temperature is set to be lower than when the actuation characteristic is fixed in accordance with the third characteristic.

When the intake valve has the actuation characteristic (or lifted in an amount and/or worked by a working angle) controlled by a variable valve actuation device in three levels, whether the rotating electric machine can ensure a motoring torque to ensure that the internal combustion engine is startable can be determined from the state of the power storage device to appropriately ensure an opportunity to intermittently operate the internal combustion engine. Furthermore, when the intake valve has the actuation characteristic fixed in accordance with the second characteristic, intermittently stopping the internal combustion engine can be permitted under a looser condition than when the intake valve has the actuation characteristic fixed in accordance with the third characteristic. Thus, while a situation in which when the internal combustion engine is intermittently stopped the engine can no longer subsequently restart can be avoided, an opportunity to intermittently operate the engine is appropriately ensured to allow the hybrid vehicle to achieve better fuel economy.

Preferably, in the present hybrid vehicle, the variable valve actuation device is configured to be capable of switching the actuation characteristic of the intake valve to any one of a first characteristic and a second characteristic allowing the amount and/or the angle to be larger than when the actuation characteristic is the first characteristic. And when the detector detects that the actuation characteristic is fixed in accordance with any one of the first and second characteristics, the control device permits intermittently stopping the internal combustion engine, based on the state of the power storage device.

When the intake valve having the actuation characteristic (or lifted in an amount and/or worked by a working angle) limited by a variable valve actuation device to two levels has the actuation characteristic fixed in the variable valve actuation device to any one of the two levels, intermittently stopping the internal combustion engine is likewise permitted if the power storage device is not limited in performance and the rotating electric machine can provide a sufficient motoring torque to ensure that the internal combustion engine is startable. This appropriately ensures an opportunity to intermittently operate the internal combustion engine to allow the hybrid vehicle to achieve better fuel economy than when the variable valve actuation device has failed or the like and thus fixes the actuation characteristic and accordingly, intermittently stopping the internal combustion engine is unconditionally prohibited.

Still preferably, when the detector detects that the actuation characteristic is fixed in accordance with the second characteristic, the control device permits intermittently stopping the internal combustion engine, based on the state of the power storage device.

When the intake valve having the actuation characteristic (or lifted in an amount and/or worked by a working angle) controlled by a variable valve actuation device in two levels is lifted in a large amount and/or worked by a large working angle via the variable valve actuation device and the internal combustion engine is impaired in startability, and in that condition the intake valve has the actuation characteristic fixed, the state of the power storage device can be referred to to permit intermittently stopping the internal combustion engine. Thus, while a situation in which when the internal combustion engine is intermittently stopped the engine can no longer subsequently restart can be avoided, an opportunity to intermittently operate the engine is appropriately ensured to allow the hybrid vehicle to achieve better fuel economy.

Furthermore, still preferably, when the detector detects that the actuation characteristic is fixed in accordance with the first characteristic the control device permits intermittently stopping the internal combustion engine.

When the intake valve having the actuation characteristic (or lifted in an amount and/or worked by a working angle) controlled by a variable valve actuation device in two or three levels is lifted in a minimum amount and/or worked by a minimum working angle via the variable valve actuation device and the internal combustion engine's startability is ensured, and the intake valve has the actuation characteristic fixed, intermittently stopping the internal combustion engine can nonetheless be permitted. This ensures an opportunity to intermittently operate the internal combustion engine to allow the hybrid vehicle to achieve better fuel economy than when the variable valve actuation device has failed or the like and thus fixes the actuation characteristic and accordingly, intermittently stopping the internal combustion engine is unconditionally prohibited.

Still preferably, the control device prohibits intermittently stopping the internal combustion engine when none of the first to third conditions is established. Alternatively, when none of the first to third conditions is established, and the hybrid vehicle has a vehicular speed equal to or higher than a prescribed speed and a prescribed condition indicating that the internal combustion engine is impaired in startability has also been established, the control device prohibits intermittently stopping the internal combustion engine.

When the internal combustion engine is impaired in startability and the intake valve has the actuation characteristic fixed, intermittently stopping the internal combustion engine is prohibited to prevent the internal combustion engine from being intermittently stopped and failing to restart.

Alternatively, preferably, when the detector detects that the actuation characteristic is fixed, and the hybrid vehicle has a vehicular speed lower then a prescribed speed, the control device also permits intermittently stopping the internal combustion engine.

When the vehicle is travelling at a low vehicular speed, the internal combustion engine is restarted with relatively small electric power charged/discharged, and if in that condition the intake valve has the actuation characteristic fixed, intermittently stopping the internal combustion engine can nonetheless be permitted. This ensures an opportunity to intermittently operate the internal combustion engine to allow the hybrid vehicle to achieve better fuel economy than when the variable valve actuation device has failed or the like and accordingly, intermittently stopping the internal combustion engine is unconditionally prohibited.

Furthermore, preferably, when the detector detects that the actuation characteristic is fixed, and the internal combustion engine is in a warm state, the control device also permits intermittently stopping the internal combustion engine.

When the internal combustion engine is in the warm state, the internal combustion engine can be restarted even with a small cranking torque, and if in that condition the intake valve has the actuation characteristic fixed, intermittently stopping the internal combustion engine can nonetheless be permitted. This ensures an opportunity to intermittently operate the internal combustion engine to allow the hybrid vehicle to achieve better fuel economy than when the variable valve actuation device controlling the intake valve's actuation characteristic has failed or the like and thus fixes the actuation characteristic and accordingly, intermittently stopping the internal combustion engine is unconditionally prohibited.

Preferably, when the amount and/or the angle are/is fixed within a prescribed range, the control device allows intermittently stopping the internal combustion engine to be permitted under a looser condition than when the amount and/or the angle are/is fixed to be larger than the prescribed range.

Thus, in response to what actuation characteristic the intake valve having fixed, with the intake valve lifted in a small amount and/or worked by a small working angle and accordingly, the internal combustion engine enhanced in startability, intermittently stopping the internal combustion engine is permitted under a looser condition. When the intake valve having the actuation characteristic controlled by the variable valve actuation device has the actuation characteristic fixed, a situation in which when the internal combustion engine is intermittently stopped the engine can no longer subsequently restart can be avoided, while an opportunity to intermittently operate the engine is appropriately ensured to allow the hybrid vehicle to achieve better fuel economy.

Preferably, the rotating electric machine is mechanically coupled with both an output shaft of the internal combustion engine and a drive shaft of the hybrid vehicle at least via a motive power transmission gear.

When a rotating electric machine that is also applicable to causing the vehicle to travel is used to output a cranking torque to start the internal combustion engine, a situation in which when the internal combustion engine is intermittently stopped the engine can no longer subsequently restart can be avoided, while an opportunity to intermittently stop the engine is appropriately ensured to allow the hybrid vehicle to achieve better fuel economy.

A major advantage of the present invention lies in that when a vehicle having an internal combustion engine with an intake valve lifted in an amount and/or worked by a working angle, as controlled by a variable valve actuation device, has the amount and/or the angle fixed, a situation in which when the internal combustion engine is intermittently stopped the engine can no longer subsequently restart can be avoided, while an opportunity to intermittently stop the engine is appropriately ensured to allow the vehicle to achieve better fuel economy.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram generally showing a configuration of a hybrid vehicle according to a first embodiment of the present invention.

FIG. 2 is a transition diagram for illustrating how an intermittent engine operation is controlled in the hybrid vehicle shown in FIG. 1.

FIG. 3 shows a configuration of an engine shown in FIG. 1.

FIG. 4 represents a relationship, as implemented in a VVL device, between a valve's displacement in amount and crank angle.

FIG. 5 is a front view of the VVL device.

FIG. 6 is a partial perspective view of the VVL device shown in FIG. 5.

FIG. 7 provides a representation for illustrating an operation provided when an intake valve is lifted in a large amount and worked by a large working angle.

FIG. 8 provides a representation for illustrating an operation provided when the intake valve is lifted in a small amount and worked by a small working angle.

FIG. 9 provides a representation of a first example of how a power storage device is limited in chargeability and dischargeability.

FIG. 10 provides a representation of a second example of how the power storage device is limited in chargeability and dischargeability.

FIG. 11 is a flowchart of a process for controlling an intermittent engine operation in the hybrid vehicle according to the first embodiment.

FIG. 12 is a flowchart of a process for controlling an intermittent engine operation in the hybrid vehicle according to a second embodiment in a first example.

FIG. 13 is a flowchart of a process for controlling an intermittent engine operation in the hybrid vehicle according to the second embodiment in a second example.

FIG. 14 is a nomograph of the hybrid vehicle shown in FIG. 1.

FIG. 15 is a flowchart of a process for controlling an intermittent engine operation in the hybrid vehicle according to the second embodiment in a third example.

FIG. 16 is a flowchart of a process for controlling an intermittent engine operation in the hybrid vehicle according to the second embodiment in a fourth example.

FIG. 17 provides a representation of the intake valve's fixed actuation characteristic, as divided in controlling the intermittent engine operation according to a third embodiment.

FIG. 18 is a table for describing a setting of reference values in controlling the intermittent engine operation according to the third embodiment.

FIG. 19 represents a relationship between the intake valve's displacement in amount and crank angle, as implemented in a VVL device that can vary the intake valve's actuation characteristic in three levels.

FIG. 20 shows an operating line of an engine including a VVL device having the actuation characteristic shown in FIG. 19.

FIG. 21 is a first flowchart of a process for controlling an intermittent engine operation according to the second embodiment having applied thereto a VVL device having the FIG. 19 actuation characteristic.

FIG. 22 is a second flowchart of a process for controlling an intermittent engine operation according to the second embodiment having applied thereto the VVL device having the FIG. 19 actuation characteristic.

FIG. 23 is a table of a setting of reference values applied in controlling an intermittent engine operation according to the third embodiment having applied thereto the VVL device having the FIG. 19 actuation characteristic.

FIG. 24 represents a relationship between the intake valve's displacement in amount and crank angle, as implemented in a VVL device that can vary the intake valve's actuation characteristic in two levels.

### DESCRIPTION OF THE PREFERRED EMBODIMENTS

Hereinafter reference will be made to the drawings to describe the present invention in embodiments. Hereinafter, a plurality of embodiments will be described. In the figures, identical or corresponding components are identically denoted, and will not be described repeatedly.

### First Embodiment

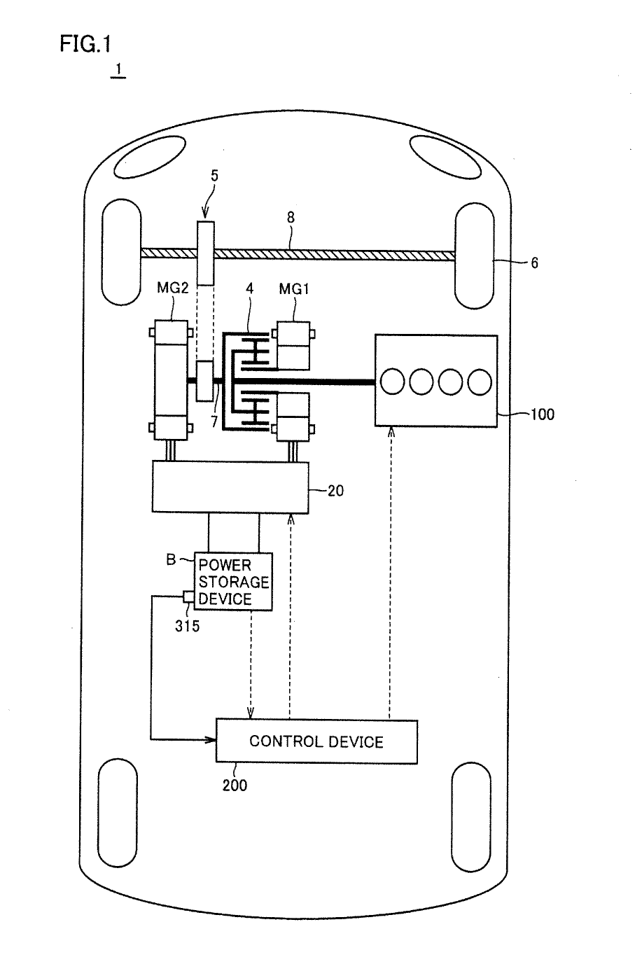

FIG. 1 is a block diagram generally showing a configuration of a hybrid vehicle according to an embodiment of the present invention.

With reference to FIG. 1, a hybrid vehicle 1 includes an engine 100, motor generators MG1 and MG2, a power split device 4, a speed reducer 5, a driving wheel 6, a power storage device B, a power control unit (PCU) 20, and a control device 200.

Engine 100 is for example an internal combustion engine which combusts a hydrocarbon based fuel, such as gasoline or light oil, to generate motive power.

Power split device 4 is configured to be capable of receiving the motive power that engine 100 generates, and dividing it to a path via an output shaft 7 to a drive shaft 8 and a path to motor generator MG1. Power split device 4 can be a planetary gear mechanism having three rotation shafts, i.e., a sun gear, a planetary gear and a ring gear. For example, motor generator MG1 can have a rotor hollowed to have a center allowing engine 100 to have a crankshaft passing therethrough to allow power split device 4 to have engine 100 and motor generators MG1 and MG2 mechanically connected thereto.

Specifically, motor generator MG1 has the rotor connected to the sun gear, engine 100 has an output shaft connected to the planetary gear, and output shaft 7 is connected to the ring gear. Output shaft 7, also connected to the rotation shaft of motor generator MG2, is mechanically coupled via speed reducer 5 to drive shaft 8 for rotating and thus driving driving wheel 6. Note that a speed reducer may further be incorporated between the rotation shaft of motor generator MG2 and output shaft 7.

Motor generator MG1, MG2 is an alternating current (AC) rotating electric machine, and is a three-phase ac synchronous, electrically motored power generator, for example. Motor generator MG1 operates as an electric power generator driven by engine 100 and also operates as an electric motor for starting engine 100, i.e., it is configured to function as an electric motor and an electric power generator.

Similarly, motor generator MG2 generates vehicular driving force transmitted to driving wheel 6 via speed reducer 5 and drive shaft 8. Furthermore, motor generator MG2 is configured to have a function of an electric motor and that of an electric power generator to generate an output torque opposite in direction to a direction in which driving wheel 6 rotates to regenerate electric power.

In the FIG. 1 exemplary configuration, motor generator MG1 can use power storage device B as a power supply to provide a torque (or cranking torque) to the output shaft (or crankshaft) of engine 100. In other words, motor generator MG1 is configured to be capable of starting engine 100. Motor generator MG1 is mechanically coupled with drive shaft 8 of hybrid vehicle 1 and the output shaft of engine 100 via a motive power transmission gear exemplified by power split device 4.

Power storage device B is a chargeably and dischargeably configured electric power storage element. Power storage device B for example includes a rechargeable battery such as a lithium ion battery, a nickel metal hydride battery or a lead acid battery, or a cell of a power storage element such as an electric double layer capacitor. Power storage device B is provided with a sensor 315 for sensing power storage device B's temperature, current, and voltage. Sensor 315 senses the temperature, current, and voltage and outputs a value thereof to control device 200. Control device 200 receives the value from sensor 315 and uses the value to calculate a state of charge (SOC) of power storage device B. The SOC is typically indicated by a currently available capacity of power storage device B relative to a full charge capacity of power storage device B in percentages. The SOC can be calculated in any known methodology.

Power storage device B is connected to PCU 20 provided for driving motor generators MG1 and MG2. Power storage device B supplies PCU 20 with electric power for generating force to drive hybrid vehicle 1. Furthermore, power storage device B stores electric power generated by motor generators MG1, MG2. Power storage device B outputs 200 V for example.

PCU 20 receives direct current (DC) electric power from power storage device B and converts the received DC electric power into alternating current (AC) electric power to drive motor generators MG1 and MG2. PCU 20 also receives AC electric power generated by motor generators MG1 and MG2 and converts the received AC electric power into DC electric power to charge power storage device B therewith.

Control device 200 controls the outputs of engine 100 and motor generators MG1 and MG2, depending on how the vehicle travels. In particular, control device 200 controls hybrid vehicle 1 to travel to allow the vehicle to travel with engine 100 stopped and motor generator MG2 serving as a source of motive power, i.e., to travel as an EV, and to travel with engine 100 in operation, i.e., to travel as an HV, in combination.

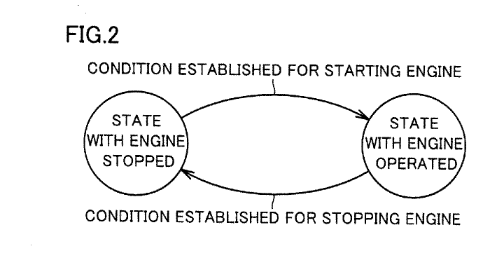

FIG. 2 is a transition diagram for illustrating how an intermittent engine operation is controlled in the hybrid vehicle shown in FIG. 1.

With reference to FIG. 2, hybrid vehicle 1 basically has engine 100 started and stopped as automatically controlled depending on how the vehicle travels. When vehicle 1 is in a state with the engine stopped and in that condition a condition is established for starting the engine, control device 200 generates an instruction to start the engine. This starts an engine starting process and hybrid vehicle 1 transitions from the state with the engine stopped to a state with the engine operated.

In contrast, when vehicle 1 is in the state with the engine operated and in that condition a condition is established for stopping the engine, control device 200 generates an instruction to stop the engine. This starts an engine stopping process and hybrid vehicle 1 transitions from the state with the engine operated to the state with the engine stopped.

For example, the condition for starting the engine, for hybrid vehicle 1, is determined by comparing with a threshold value an output parameter Pr used to quantitatively indicate an output (power or torque) that hybrid vehicle 1 is required to provide. In other words, the condition for starting the engine is established when output parameter Pr exceeds a prescribed threshold value Pth1.

For example, output parameter Pr is total required power Pt1 of hybrid vehicle 1. Total required power Pt1 can be calculated as follows: a required torque Tr* reflecting an amount by which the driver operates the accelerator pedal is multiplied by the rotational speed of drive shaft 8 to obtain required driving power Pr*, which and a required charged and discharged power Pchg for controlling power storage device B in SOC are added together (i.e., Pt1=Pr*+Pchg).

Required torque Tr* is set to higher values for larger amounts by which the accelerator pedal is operated. Furthermore, preferably, for a given amount by which the accelerator pedal is operated, in combination with vehicular speed, required torque Tr* is set to have smaller values for higher vehicular speeds. Alternatively, required torque Tr* can also be set in accordance with a previously set map or operation expression, depending on a road surface condition (a road surface gradient, a road surface friction coefficient, and the like).

Required charged and discharged power Pchg is set to be larger than zero for charging power storage device B when it has an SOC decreased to be lower than a control target value or range, whereas required charged and discharged power Pchg is set to be smaller than zero (or the power storage device is discharged) when it has an increased SOC. In other words, required charged and discharged power Pchg is set to allow power storage device B to have an SOC close to a prescribed control target (value or range).

Control device 200 controls the outputs of engine 100 and motor generators MG1 and MG2 to generate total required power Pt1. For example, when total required power Pt1 is small, such as when the vehicle travels at low speed, engine 100 is stopped. In contrast, when the accelerator pedal is operated for acceleration, total required power Pt1 increases, and accordingly, the condition for starting the engine is established, and engine 100 is thus started. Note that the condition for starting the engine can also be established and engine 100 can thus also be started when engine 100 is at low temperature or the like and accordingly, it is necessary to heat a three-way catalyst 112.

On the other hand, the condition for stopping the engine is established when output parameter Pr (total required power Pt1) is decreased to be lower than a prescribed threshold value Pth2. Note that preferably, threshold value Pth1 applied for the condition for starting the engine has a value different from that of threshold value Pth2 applied for the condition for stopping the engine (i.e., Pth1>Pth2) to prevent frequently switching the state with the engine stopped to the state with the engine operated and vice versa.

The engine is started to warm three-way catalyst 112 or the like, and once the catalyst or an engine coolant has been heated to be higher in temperature (as sensed by water temperature sensor 309) than a prescribed temperature, the condition for stopping the engine is established. Furthermore, the condition for stopping the engine is also established when the user operates a key switch and accordingly, driving the vehicle is stopped (e.g., when an IG switch is turned off).

Thus, once hybrid vehicle 1 has conditions established for starting and stopping the engine, hybrid vehicle 1 has engine 100 started and stopped as controlled and can thus achieve better fuel economy. More specifically, output parameter Pr can be considered, as described above, so that at a low output, which is when the engine's efficiency is decreased, operating engine 100 is avoided by intermittently operating engine 100 to reduce its fuel consumption.

Note that whether engine 100 is operated or stopped may be determined with reference to output parameter Pr other than total required power Pt1 described above. For example, output parameter Pr may be a required torque or acceleration calculated via reflecting at least by how much amount the accelerator pedal is operated, or output parameter Pr may be by how much amount the accelerator pedal is operated per se. Furthermore, engine 100 may intermittently be operated under any other conditions than those described above by way of example for starting and stopping the engine.

Hereinafter will be described how an engine having a variable valve actuation device is configured.

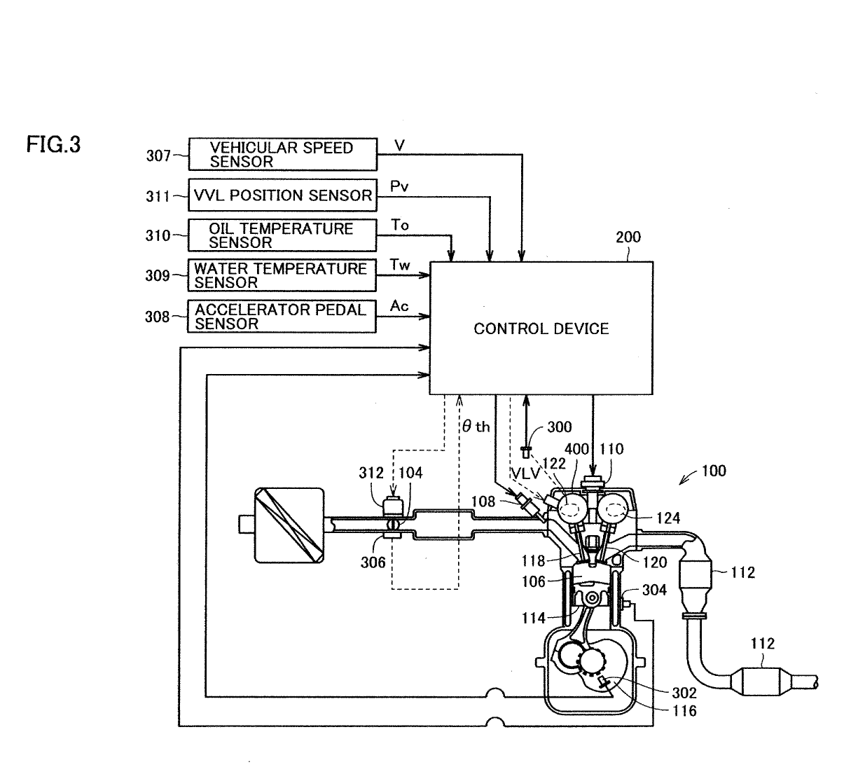

FIG. 3 shows a configuration of engine 100 shown in FIG. 1.

With reference to FIG. 3, how much amount of air is taken into engine 100 is adjusted by a throttle valve 104. Throttle valve 104 is an electronically controlled throttle valve driven by a throttle motor 312.

An injector 108 injects fuel towards an air intake port. At the intake port, the fuel is mixed with air. The air-fuel mixture is introduced into cylinder 106 when intake valve 118 opens.

Note that injector 108 may be provided as a direct injection injector to inject fuel directly into cylinder 106. Alternatively, injector 108 may be provided for both port injection and direct injection.

Cylinder 106 receives the air-fuel mixture, which is ignited by an ignition plug 110 and thus combusted. The combusted air-fuel mixture, or exhaust gas, is purified by three-way catalyst 112 and subsequently discharged outside the vehicle. As the air-fuel mixture is combusted, a piston 114 is pushed down and a crankshaft 116 thus rotates.

Cylinder 106 has a head or top portion provided with intake valve 118 and an exhaust valve 120. When and in what amount cylinder 106 receives air is controlled by intake valve 118. When and in what amount cylinder 106 discharges exhaust gas is controlled by exhaust valve 120. Intake valve 118 is driven by a cam 122. Exhaust valve 120 is driven by a cam 124.

Intake valve 118 has an actuation characteristic, as controlled by a variable valve lift (VVL) device 400, as will more specifically be described hereinafter. Hereinafter, intake valve 118 has the actuation characteristic controlled as an amount of lifting the intake valve and a working angle on the intake valve by way of example. Note that exhaust valve 120 may also be lifted in an amount and/or worked by a working angle, as controlled. Furthermore, a variable valve timing (VVT) device may be combined with VVL device 400 to control timing when the valve should be opened/closed.

Control device 200 controls a throttle angle θth, timing when to provide ignition, timing when to inject fuel, the amount of fuel to be injected, the intake valve's operating condition (timing when to open/close the valve, the amount of lifting it, the working angle, and the like) to allow engine 100 to achieve an operating state as desired. Control device 200 receives signals from a cam angle sensor 300, a crank angle sensor 302, a knock sensor 304, a throttle angle sensor 306, a vehicular speed sensor 307, an accelerator pedal sensor 308, a water temperature sensor 309, an oil temperature sensor 310, and a VVL position sensor 311.

Cam angle sensor 300 outputs a signal indicating a cam's position. Crank angle sensor 302 outputs a signal indicating the rotational speed of crankshaft 116 (or the engine's rotational speed) and the angle of rotation of crankshaft 116. Knock sensor 304 outputs a signal indicating how engine 100 vibrates in intensity. Throttle angle sensor 306 outputs a signal indicating throttle angle θth.

Water temperature sensor 309 senses temperature Tw of a water coolant of engine 100. Oil temperature sensor 310 senses temperature To of a lubricant oil of engine 100. The water coolant's temperature Tw and the lubricant oil's temperature To that are sensed are input to control device 200. Accelerator pedal sensor 308 senses by how much amount Ac the driver operates the accelerator pedal (not shown). Vehicular speed sensor 307 senses vehicular speed V of hybrid vehicle 1 from the rotational speed of drive shaft 8 and the like. Amount Ac by which the accelerator pedal is operated, as sensed by accelerator pedal sensor 308, and vehicular speed V as sensed by vehicular speed sensor 307, are input to control device 200.

Furthermore, VVL position sensor 311 is configured to sense data Pv indicating the current actuation characteristic of intake valve 118 controlled by VVL device 400. Data Pv sensed by VVL position sensor 311 is input into control device 200. That is, control device 200 can detect the current value of the amount of lifting the intake valve and that of the working angle on the intake valve from data Pv received from VVL position sensor 311.

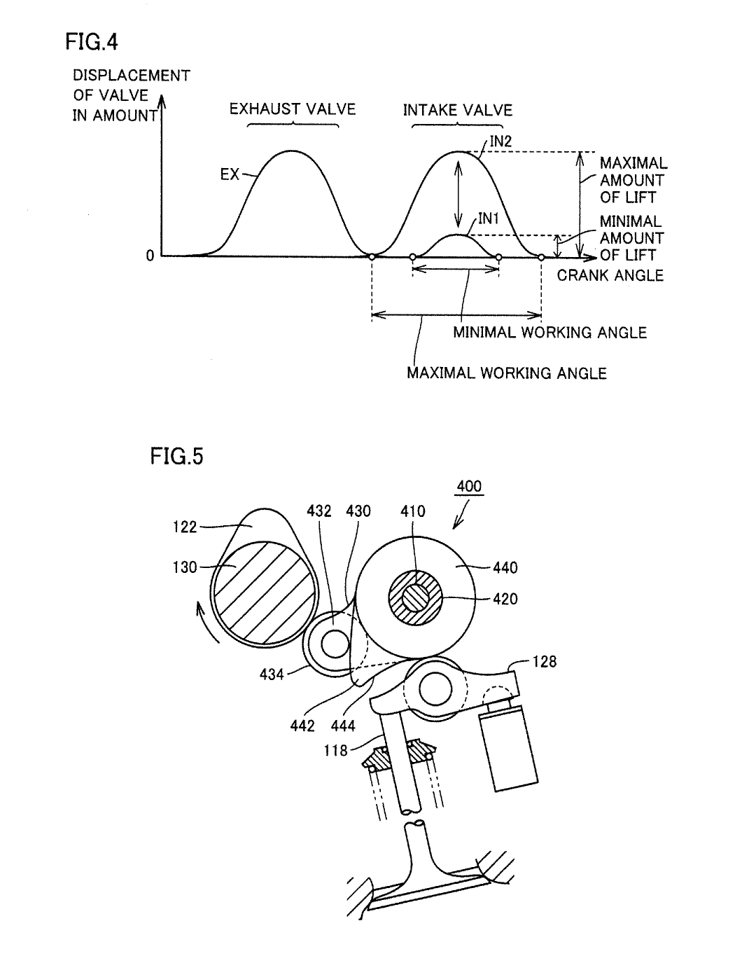

FIG. 4 represents a relationship, as implemented in VVL device 400, between a valve's displacement in amount and crank angle. With reference to FIG. 4, for the exhaust stroke, exhaust valve 120 opens and closes, and for the intake stroke, intake valve 118 opens and closes. Exhaust valve 120 displaces in an amount represented by a waveform EX, and intake valve 118 displaces in amounts represented by waveforms IN1 and IN2.

The valve's displacement in amount indicates an amount by which intake valve 118 is displaced from its closed position. The amount of lift indicates an amount by which intake valve 118 is displaced when the valve peaks in how much in degree it is opened. The working angle is a crank angle assumed after intake valve 118 is opened before it is closed.

Intake valve 118 has an actuation characteristic varied by VVL device 400 between waveforms IN1 and IN2. Waveform IN1 corresponds to a minimal amount of lift and a minimal working angle. Waveform IN2 corresponds to a maximal amount of lift and a maximal working angle. In VVL device 400, a larger amount of lift is accompanied by a larger working angle. In other words, the present embodiment presents VVL device 400 by way of example to allow intake valve 118 to be lifted in an amount and worked by a working angle as an actuation characteristic of intake valve 118, as modified in VVL device 400.

FIG. 5 is a front view of VVL device 400 serving as an exemplary device that controls an amount of lifting intake valve 118 and a working angle on intake valve 118.

With reference to FIG. 5, VVL device 400 includes a driving shaft 410 extending in one direction, a support pipe 420 that covers driving shaft 410 circumferentially, and an input arm 430 and a rocking cam 440 disposed in alignment on an outer circumferential surface of support pipe 420 in a direction along the axis of driving shaft 410. Driving shaft 410 has a tip with an actuator (not shown) connected thereto to cause driving shaft 410 to provide rectilinear motion.

VVL device 400 is provided with a single input arm 430 associated with a single cam 122 provided for each cylinder. Input arm 430 has opposite sides provided with two rocking cams 440 associated with a pair of intake valves 118, respectively, provided for each cylinder.

Support pipe 420 is formed in a hollowed cylinder and disposed in parallel to a cam shaft 130. Support pipe 420 is secured to a cylinder head and thus prevented from axially moving or rotating.

Support pipe 420 internally receives driving shaft 410 to allow driving shaft 410 to slide axially. Support pipe 420 has an outer circumferential surface provided thereon with input arm 430 and two rocking cams 440 to be rockable about an axial core of driving shaft 410 and also prevented from moving in a direction along the axis of driving shaft 410.

Input arm 430 has an arm portion 432 projecting in a direction away from the outer circumferential surface of support pipe 420, and a roller portion 434 rotatably connected to a tip of arm portion 432. Input arm 430 is provided to allow roller portion 434 to be disposed at a position allowing roller portion 434 to abut against cam 122.

Rocking cam 440 has a nose portion 442 in a generally triangular form projecting in a direction away from the outer circumferential surface of support pipe 420. Nose portion 442 has one side having a recessed, curved cam surface 444. Intake valve 118 is provided with a valve spring, which is biased to apply force to in turn press against cam surface 444 a roller rotatably attached to a rocker arm 128.

Input arm 430 and rocking cam 440 rock together about the axial core of driving shaft 410. Accordingly, as cam shaft 130 rotates, input arm 430 that abuts against cam 122 rocks, and as input arm 430 thus moves, rocking cam 440 also rocks. This motion of rocking cam 440 is transmitted via rocker arm 128 to intake valve 118 to thus open/close intake valve 118.

VVL device 400 further includes a device around the axial core of support pipe 420 to vary a relative phase difference between input arm 430 and rocking cam 440. The device that varies the relative phase difference allows intake valve 118 to be lifted in an amount and worked by a working angle, as modified as appropriate.

More specifically, input arm 430 and rocking cam 440 with an increased relative phase difference allow rocker arm 128 to have a rocking angle increased relative to that of input arm 430 and rocking cam 440 and intake valve 118 to be lifted in an increased amount and worked by an increased working angle.

In contrast, input arm 430 and rocking cam 440 with a reduced relative phase difference allow rocker arm 128 to have a rocking angle reduced relative to that of input arm 430 and rocking cam 440 and intake valve 118 to be lifted in a reduced amount and worked by a reduced working angle. For example, VVL position sensor 311 can be configured to sense a mechanical relative phase difference between input arm 430 and rocking cam 440 as data Pv. Note that VVL position sensor 311 may have any configuration that allows its sensed value to be used to directly or indirectly obtain the actuation characteristic of intake valve 118, i.e., the amount of lifting intake valve 118 and the working angle on intake valve 118.

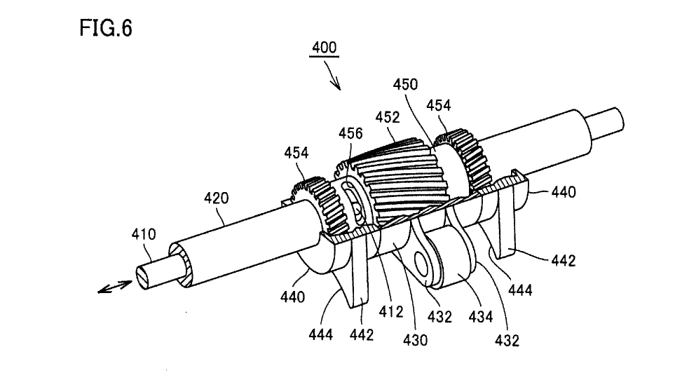

FIG. 6 is a partial perspective view of VVL device 400. FIG. 6 shows VVL device 400 partially exploded to help to clearly understand its internal structure.

With reference to FIG. 6, input arm 430 and two rocking cams 440, and an outer circumferential surface of support pipe 420 define a space therebetween, and in that space, a slider gear 450 is accommodated that is supported to be rotatable relative to support pipe 420 and also axially slidable. Slider gear 450 is provided slidably on support pipe 420 axially.

Slider gear 450 as seen axially has a center provided with a helically right handed splined helical gear 452. Slider gear 450 as seen axially also has opposite sides provided with helically left handed splined helical gears 454s, respectively, with helical gear 452 posed therebetween.

An internal circumferential surface of input arm 430 and two rocking cams 440 that defines the space that has slider gear 450 accommodated therein, is helically splined to correspond to helical gears 452 and 454. More specifically, input arm 430 is helically right handed splined to mesh with helical gear 452. Furthermore, rocking cam 440 is helically left handed splined to mesh with helical gear 454.

Slider gear 450 is provided with an elongate hole 456 located between one helical gear 454 and helical gear 452 and extending circumferentially. Furthermore, although not shown, support pipe 420 is provided with an elongate hole extending axially and overlapping a portion of elongate hole 456. Driving shaft 410, inserted in support pipe 420, is integrally provided with a locking pin 412 to project through those portions of elongate hole 456 and the unshown elongate hole which overlap each other.

Driving shaft 410 is coupled with an actuator (not shown), and when the actuator is operated, driving shaft 410 moves in its axial direction, and accordingly, slider gear 450 is pushed by locking pin 412 and helical gears 452 and 454 move in a direction along the axis of driving shaft 410 concurrently. While helical gears 452 and 454 are thus moved, input arm 430 and rocking cam 440 splined and thus engaged therewith do not move in the axial direction. Accordingly, input arm 430 and rocking cam 440, helically splined and thus meshed, pivot about the axial core of driving shaft 410.

Note that input arm 430 and rocking cam 440 are helically splined in opposite directions, respectively. Accordingly, input arm 430 and rocking cam 440 pivot in opposite directions, respectively. This allows input arm 430 and rocking cam 440 to have a relative phase difference varied to allow intake valve 118 to be lifted in a varying amount and worked by a varying working angle, as has been previously described.

For example, VVL position sensor 311 shown in FIG. 3 is configured to have a mechanism capable of sensing a mechanical phase difference between input arm 430 and rocking cam 440. Alternatively, VVL position sensor 311 can also be configured to have a mechanism capable of sensing an axial position of driving shaft 410 moved by an actuator (not shown).

Control device 200 controls by how much amount the actuator that causes driving shaft 410 to move in rectilinear motion should be operated to control the amount of lifting intake valve 118 and the working angle on intake valve 118. The actuator can for example be an electric motor. In that case, the actuator or electric motor typically receives electric power from a battery (an auxiliary battery) other than power storage device B. Alternatively, the actuator can also be configured to be operated by the hydraulic pressure generated from an oil pump driven by engine 100.

Note that the VVL device is not limited to the form exemplified in FIGS. 5 and 6. For example, the VVL device may be a VVL device which electrically drives the valve, a VVL device which hydraulically drives the valve, or the like. In other words, in the present embodiment, intake valve 118 may have the actuation characteristic (or be lifted in an amount and worked by a working angle) varied by any scheme, and any known scheme may be applied as appropriate.

The intake valve's actuation characteristic and the engine's operation have a relationship, as will be described hereinafter.

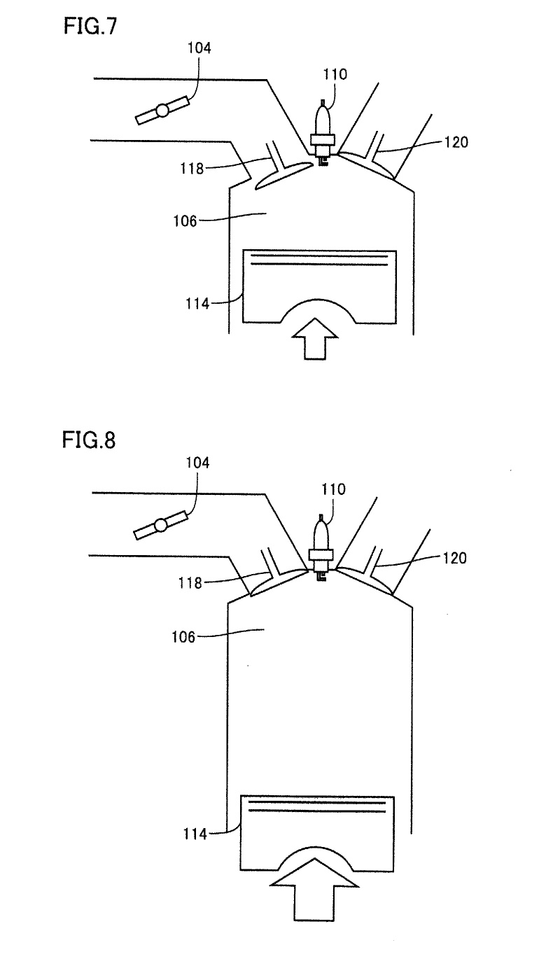

FIG. 7 provides a representation for illustrating an operation provided when intake valve 118 is lifted in a large amount and worked by a large working angle. FIG. 8 provides a representation for illustrating an operation provided when intake valve 118 is lifted in a small amount and worked by a small working angle.

With reference to FIGS. 7 and 8, when intake valve 118 is lifted in a large amount and worked by a large working angle, intake valve 118 is timed to close late, and accordingly, engine 100 is operated in the Atkinson cycle. More specifically, the intake stroke is performed to allow cylinder 106 to take in air, which is partially returned outside cylinder 106, and accordingly, the compression stroke is performed with the air compressed by a reduced force, i.e., with a reduced compressive reaction (i.e., a decompression effect). This allows the engine to be started with reduced vibration. The hybrid vehicle has engine 100 operated intermittently and accordingly, the engine starting process is performed more frequently, and accordingly, it is preferable that the hybrid vehicle obtain the decompression effect and that to do so, the hybrid vehicle have the engine started with intake valve 118 lifted in an increased amount and worked by an increased working angle. On the other hand, lifting intake valve 118 in a large amount and working it by a large working angle result in a reduced compression ratio and hence impaired ignitability. In other words, the engine's startability is relatively impaired.

In contrast, when intake valve 118 is lifted in a small amount and worked by a small working angle, intake valve 118 is timed to close early, and accordingly, an increased compression ratio is provided. This can improve ignitability for low temperature and also improve engine torque response. Accordingly, starting the engine with intake valve 118 lifted in a smaller amount and worked by a smaller working angle ensures that the engine starts. On the other hand, lifting intake valve 118 in a small amount and working it by a small working angle provide an increased compressive reaction, and hence increased vibration in starting the engine. In other words, when intake valve 118 is lifted in a small amount and worked by a small working angle (see FIG. 8), the engine has excellent startability.

While FIG. 7 and FIG. 8 show a characteristic provided when VVL device 400 allows intake valve 118 to be lifted in a varying (or increasing and decreasing) amount and worked by a varying (or increasing and decreasing) working angle, either lifting intake valve 118 in a varying (or increasing and decreasing) amount or working intake valve 118 by a varying (or increasing and decreasing) working angle also allows a qualitatively equivalent feature to appear.

Motor generator MG1 operates to start engine 100, as will be described hereinafter.

When engine 100 in a stopped state is started by the engine starting process, engine 100 is cranked by motor generator MG1, as shown in FIG. 1. Accordingly, when the engine starting process is started with motor generator MG1 stopped or positively rotated, discharging power storage device B is involved, and motor generator MG1 outputs a torque to crank engine 100. In contrast, when the engine starting process is started with motor generator MG1 negatively rotated, the cranking torque by motor alternator MG1 is accompanied by charging power storage device B.

Motor generator MG1 thus generates a cranking torque, with power storage device B charged/discharged, to start the engine. Accordingly, when power storage device B is limited in chargeability and dischargeability, motor generator MG1 also generates a cranking torque limited in magnitude (or absolute value).

Generally, power storage device B is charged/discharged as limited by a limit value set as an upper limit value Wout for electric power discharged and an upper limit value Win for electric power charged, and power storage device B is thus limited in chargeability and dischargeability.

Upper limit value Wout for electric power discharged indicates an upper limit value set for electric power discharged, and it is set to be equal to or larger than zero. Wout=0 means that discharging power storage device B is prohibited. Similarly, upper limit value Win for electric power charged indicates an upper limit value set for electric power charged, and it is set to be equal to or smaller than zero. Win=0 means that charging power storage device B is prohibited.

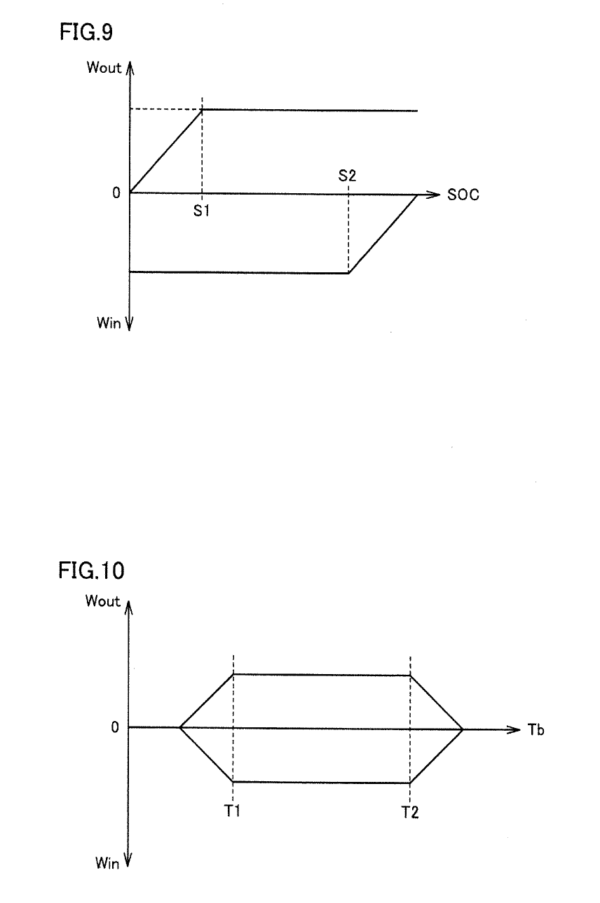

FIGS. 9 and 10 provide representations for illustrating how power storage device B is limited in chargeability and dischargeability. FIG. 9 represents how upper limit value Wout for electric power discharged and upper limit value Win for electric power charged are limited with respect to the SOC of power storage device B, and FIG. 10 represents how upper limit value Wout for electric power discharged and upper limit value Win for electric power charged are limited with respect to temperature Tb of power storage device B.

With reference to FIG. 9, for a low SOC range (SOC<S1), discharging power storage device B is limited, and to do so, upper limit value Wout for electric power discharged is set to be lower than for a range of SOC≧S1. Similarly, for a high SOC range (SOC>S2), charging power storage device B is limited, and to do so, upper limit value Win for electric power charged is set to be smaller in absolute value than for a range of SOC≦S2.

With reference to FIG. 10, when power storage device B is a rechargeable battery, then, at low temperature and high temperature, the battery has an increased internal resistance, and upper limit value Wout for electric power discharged and upper limit value Win for electric power charged are limited. For example, upper limit value Wout for electric power discharged and upper limit value Win for electric power charged are limited when power storage device B has temperature Tb in a low temperature range (Tb<T1) and a high temperature range (Tb>T2) as compared with an ordinary temperature range (T1≦Tb≦T2).

Power storage device B's SOC and/or temperature Tb are/is thus considered in limiting power storage device B in chargeability and dischargeability to reduce electric power charged/discharged to/from power storage device B. Motor generators MG1 and MG2 each produce a torque controlled by a value limited such that motor generators MG1 and MG2 have a sum of their input and output electric powers (i.e., torque×rotational speed) falling within a range between Win and Wout to protect power storage device B.

As such, when engine 100 is started with power storage device B limited in chargeability and dischargeability motor generator MG1 can only output a cranking torque having a reduced maximum (or absolute) value. The reduced cranking torque in turn results in relatively reduced engine startability.

In the present embodiment, when intake valve 118 having an actuation characteristic controlled by VVL device 400 has the actuation characteristic fixed for some reason, a control is applied to appropriately ensure an opportunity to perform an intermittent engine operation. Note that, as has been described previously, the present embodiment presents VVL device 400 by way of example to control an actuation characteristic of intake valve 118 that is an amount of lifting intake valve 118 and a working angle on intake valve 118.

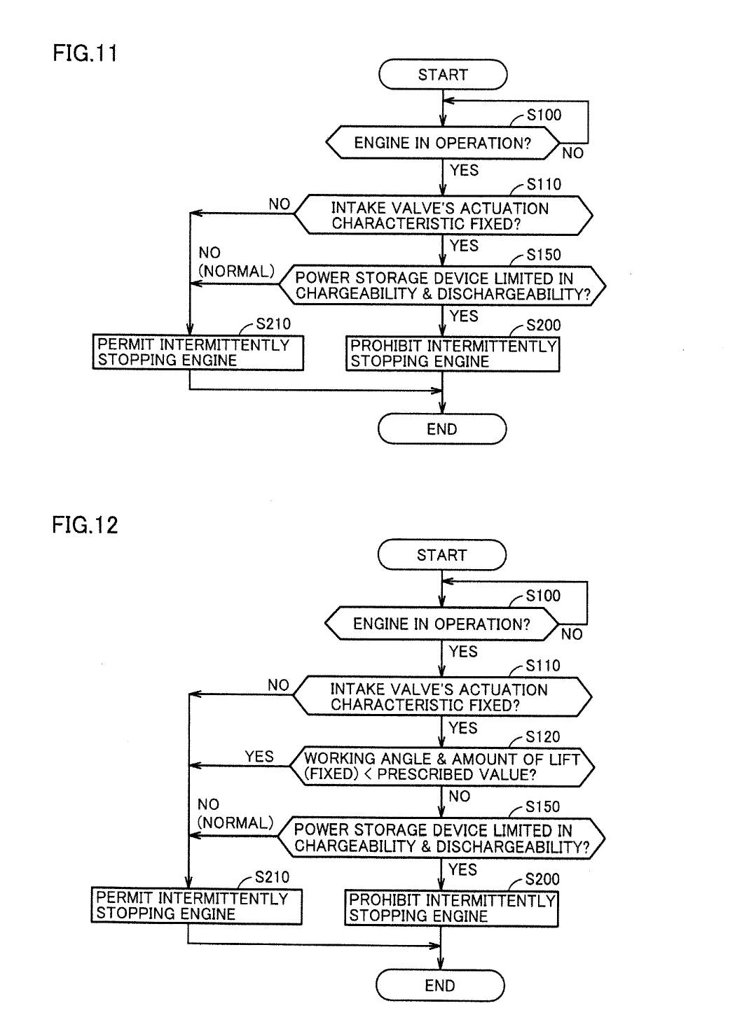

FIG. 11 is a flowchart of a process for controlling an intermittent engine operation in the hybrid vehicle according to the first embodiment. The FIG. 11 process can be performed by control device 200.

With reference to FIG. 11, when the engine is in operation, i.e., for YES in Step S100, control device 200 proceeds to Step S110 et. seq. When the engine is in operation (YES in Step S100), control device 200 proceeds to Step S110 to determine whether intake valve 118 having the actuation characteristic controlled by VVL device 400 has the actuation characteristic fixed for some reason. For example, a decision of YES is made for Step S110 when VVL position sensor 311 provides an output that is unchanged for more than a prescribed period of time in a state different from a control value issued to VVL device 400 to lift the intake valve in an amount and work the intake valve by a working angle. As described above, in Step S110, a decision of YES can be made not only when VVL device 400 has failed but also when low temperature or the like results in a temporarily fixed actuation characteristic while VVL device 400 normally operates.

When intake valve 118 has the actuation characteristic fixed (YES in S110), control device 200 proceeds to Step S150 to refer to a state of power storage device B associated with a cranking torque that motor generator MG1 can output to permit intermittently stopping the engine.

For example, in Step S150, whether power storage device B is limited in chargeability and dischargeability is determined. More specifically, whether power storage device B is limited in chargeability and dischargeability more than normal to such an extent that a cranking torque of a prescribed amount that is required for smoothly starting engine 100 cannot be ensured, is determined

When power storage device B is normal in chargeability and dischargeability, it ensures that while intake valve 118 has the actuation characteristic (or is lifted in an amount and worked by a working angle) fixed, motor generator MG1 outputs a sufficient cranking torque, and hence ensures that engine 100 is startable. In other words, it is less likely that when engine 100 is intermittently stopped it fails to subsequently restart.

When power storage device B is limited in chargeability and dischargeability and motor generator MG1 can only output a cranking torque smaller than normal (NO in S150), and in that condition engine 100 is intermittently stopped under some conditions, engine 100 may not be able to subsequently normally start.

Accordingly, when power storage device B is limited in chargeability and dischargeability (YES in S150), control device 200 proceeds to Step S200 to prohibit intermittently stopping engine 100. In that case, in controlling the intermittent engine operation, as shown in FIG. 2, if the vehicle is in the state with the engine operated and the condition for stopping the engine has also been established, issuing the instruction to stop the engine is nonetheless prohibited.

On the other hand, when power storage device B is not limited in chargeability and dischargeability, i.e., when power storage device B has chargeability and dischargeability as normal (NO in S150), control device 200 proceeds to Step S210 to permit intermittently stopping engine 100. When intermittently stopping engine 100 is permitted, then, as shown in FIG. 2, engine 100 can be intermittently operated for better fuel economy in response to the conditions for starting and stopping the engine being established depending on how the vehicle's driven state varies.

The FIG. 11 process is repeatedly performed so that while engine 100 is in operation, the Steps S110 and S150 decisions are followed to prohibit or permit intermittently stopping the engine to thus periodically control the intermittent engine operation.

Whether power storage device B is limited in chargeability and dischargeability (S150) can be determined monistically by referring to a cranking torque that can be output to determine in what degree power storage device B is limited in chargeability and dischargeability with power storage device B's upper limit value Win for electric power charged and upper limit value Wout for electric power discharged serving as parameters. In other words, whether power storage device B is limited in chargeability and dischargeability can be determined by comparing Win and Wout depending on the current state of power storage device B with a reference value.

Note that upper limit value Win for electric power charged and upper limit value Wout for electric power discharged may not be used or the upper limit values and in addition thereto a condition for the SOC and/or a condition for temperature may be used to determine whether power storage device B is limited in chargeability and dischargeability. For example, the condition for the SOC can be defined by whether the current SOC departs from a normal SOC range (S1-S2) indicated in FIG. 9 (i.e., whether it is in a low SOC range or a high SOC range). Furthermore, the condition for temperature can be defined by whether the power storage device B departs in temperature from a prescribed temperature range (T1-T2) indicated in FIG. 9 (i.e., whether it is in a low temperature range or a high temperature range). Alternatively, for the condition for temperature, engine 100's startability may be considered and only when power storage device B has temperature within the low temperature range, it may be determined that power storage device B is limited in chargeability and dischargeability.

For example, in Step S150, a state of power storage device B that is indicated by upper limit value Win for electric power charged, upper limit value Wout for electric power discharged, and temperature Tb is referred to to determine whether such a sufficient cranking torque as described above is ensured. For example, when at least any one of Wout>W1 (a first condition), |Win|>W2 (a second condition), and Tb>T1 (a third condition) has been established, it can be determined that power storage device B is not limited in chargeability and dischargeability (NO in S150), whereas when none of the first to third conditions is established, it can be determined that power storage device B is limited in chargeability and dischargeability (YES in S150).

Note that W1, W2, and T1 are prescribed values predetermined through an experiment performed in a real machine or the like. In particular, T1 is a prescribed value predetermined for determining that power storage device B is not in a low temperature condition that imposes limitation on charging and discharging power storage device B. Note that, for temperature Tb, Tb>T1 is at least determined as the third condition. This is because, as will be described hereinafter, high temperature facilitates engine 100 to attain a warm state and thus enhances its startability. Alternatively, Tb>T1 and Tb<T2 may together be set as the third condition in view of the FIG. 10 characteristic.

Thus, in the first embodiment, when VVL device 400 has failed or been stuck at extremely low temperature or the like and accordingly, the intake valve has the actuation characteristic (or is lifted in an amount and worked by a working angle) fixed, intermittently stopping engine 100 is not unconditionally prohibited, and when a cranking torque can be ensured to ensure that engine 100 is startable, intermittently stopping engine 100 is permitted. Thus, while a situation in which when engine 100 is intermittently stopped engine 100 can no longer subsequently restart can be avoided, an opportunity to intermittently stop engine 100 is appropriately ensured to allow the hybrid vehicle to achieve better fuel economy.

### Second Embodiment

In the first embodiment, when the intake valve has an actuation characteristic (or is lifted in an amount and worked by a working angle) fixed, whether a cranking torque is ensured is noted and what state power storage device B has is referred to to accordingly control the intermittent engine operation. In a second embodiment, a condition other than the above is additionally combined to control the intermittent engine operation, as will be described hereinafter.

FIG. 12 is a flowchart of a process for controlling an intermittent engine operation in the hybrid vehicle according to the second embodiment in a first example. The FIG. 12 process can be performed by control device 200, similarly as done in the FIG. 11 process.

When FIG. 12 is compared with FIG. 11, control device 200 performs Steps S100 and S110, similarly as done in FIG. 11, and when intake valve 118 has the actuation characteristic fixed (YES in S110), control device 200 proceeds to Step S120 to determine whether the intake valve is lifted in a fixed amount and worked by a fixed working angle that are smaller than a prescribed value (or a threshold value).

As shown in FIG. 8, when intake valve 118 is lifted in a small amount and worked by a small working angle, engine 100 has an increased compression ratio and is accordingly improved in ignitability for low temperature and also improved in startability. As such, if power storage device B only has electric power to provide a small cranking torque, engine 100 can nonetheless be intermittently stopped without failing to restart.

Accordingly, when control device 200 determines from an output received from VVL position sensor 311 that intake valve 118 is lifted in a smaller amount and worked by a smaller working angle than the threshold value (YES in S120) control device 200 proceeds to Step S210 to permit intermittently stopping engine 100.

In contrast, if the intake valve has the actuation characteristic fixed such that intake valve 118 is lifted in an amount and worked by a working angle that are equal to or larger than the threshold value (NO in S120), control device 200 performs Step S150, similarly as done in FIG. 11. Thus when power storage device B is in a state ensuring a cranking torque, intermittently stopping engine 100 is permitted, whereas when it is difficult to ensure the cranking torque, intermittently stopping engine 100 is prohibited.

The FIG. 12 flowchart (or the second embodiment in the first example) is compared with the first embodiment as follows: when the intake valve has the actuation characteristic, i.e., is lifted in an amount and worked by a working angle, fixed with the amount and angle smaller than a prescribed value (YES in S120), and power storage device B is limited in chargeability and dischargeability (YES in S150), intermittently stopping engine 100 is nonetheless permitted. Furthermore, when power storage device B is not limited in chargeability and dischargeability (NO in S150), and the fixed amount and angle are equal to or larger than the prescribed value (NO in S120), intermittently stopping engine 100 is nonetheless permitted. In other words, the FIG. 12 process may have Step S120 performed when Step S150 provides a decision of YES.

Thus the second embodiment in the first example allows the current value of the amount of lifting intake valve 118 and working angle on intake valve 118 that are fixed to be further be considered to further ensure an opportunity to intermittently operate engine 100 while avoiding a situation in which when engine 100 is intermittently stopped engine 100 can no longer subsequently restart. This further ensures an opportunity for the hybrid vehicle to have the intermittent engine operation for better fuel economy.

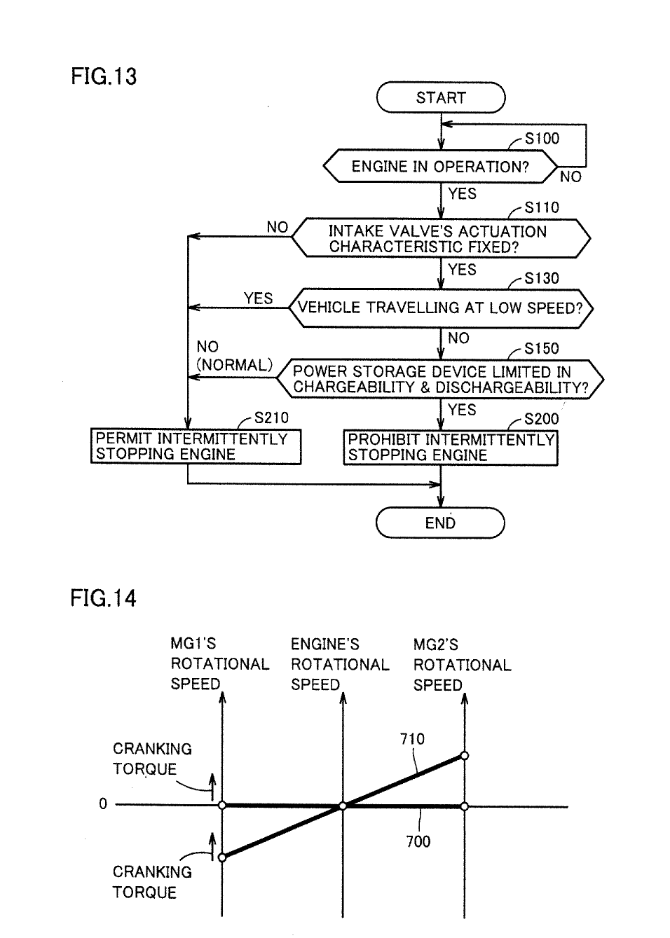

FIG. 13 is a flowchart of a process for controlling an intermittent engine operation in the hybrid vehicle according to the second embodiment in a second example. The FIG. 13 process can be performed by control device 200, similarly as done in the FIG. 11 process.

When FIG. 13 is compared with FIG. 11, control device 200 performs Steps S100 and S110, similarly as done in FIG. 11, and when intake valve 118 has the actuation characteristic fixed (YES in S110), control device 200 proceeds to Step S130 to determine whether the vehicle is currently travelling at low speed.

The FIG. 1 hybrid vehicle 1 has motor generator MG1, engine 100, and motor generator MG2 mutually coupled by power split device 4 that is a planetary gear mechanism. Accordingly, motor generator MG2, motor generator MG1, and engine 100 have their respective rotational speeds in a relationship connecting them by a straight line as shown in a nomographic chart shown in FIG. 14.

With reference to FIG. 14, when motor generator MG2 is activated and at that time engine 100 is also started, engine 100 is started in a state indicated by a line 700. Accordingly, motor generator MG1 outputs a cranking torque that is a positive torque from a state with a rotational speed of zero.

On the other hand, when the vehicle travels with engine 100 stopped and motor generator MG2's output used, motor generator MG2, engine 100, and motor generator MG1 have rotational speeds, respectively, in a state indicated by a line 710. In this state, motor generators MG2 and MG1 have rotational speeds (positively and negatively), respectively, proportional to the vehicular speed of hybrid vehicle 1.

If engine 100 is started from the state indicated by line 710, motor generator MG1 generates a torque for changing its rotational speed in a positive direction (in the figure, an upward direction) to start engine 100. This corresponds to a cranking torque that motor generator MG1 generates in starting the engine.

As the cranking torque is output, power storage device B is charged with/discharges electric power. The charged/discharged electric power is determined by a product of motor generator MG1's rotational speed and torque. Accordingly, when the engine starting process is started with hybrid vehicle 1 travelling at high vehicular speed, motor generator MG1 has a large rotational speed (in absolute value), and accordingly, power storage device B is charged with/discharges larger electric power (in absolute value) as motor generator MG1 generates a cranking torque.

In contrast, when the engine starting process is started with hybrid vehicle 1 travelling at low vehicular speed, motor generator MG1 has a small rotational speed (in absolute value), and accordingly, power storage device B is charged with/discharges smaller electric power (in absolute value) as motor generator MG1 generates a cranking torque. As such, if power storage device B is limited in chargeability and dischargeability (YES in S150), i.e., if motor generator MG1 generates a small cranking torque, engine 100 can be intermittently stopped without failing to restart.

Accordingly, when control device 200 determines from an output of vehicular speed sensor 307 (see FIG. 3) that the vehicle has a vehicular speed smaller than a reference value (YES in S130) control device 200 determines that the vehicle is travelling at low speed and control device 200 proceeds to Step S210 to permit intermittently stopping engine 100.

In contrast, if the vehicular speed is higher than the reference value, i.e., if the vehicle is travelling at intermediate to high speed (NO in S130), control device 200 performs Step S150, similarly as done in FIG. 11. Thus when power storage device B is in a state ensuring a cranking torque, intermittently stopping engine 100 is permitted, whereas when it is difficult to ensure the cranking torque, intermittently stopping engine 100 is prohibited.

The FIG. 13 flowchart (or the second embodiment in the second example) is compared with the first embodiment as follows: when the vehicle is travelling at low speed (YES in S130), and power storage device B is limited in chargeability and dischargeability (YES in S150), intermittently stopping engine 100 is nonetheless permitted. Furthermore, when power storage device B is not limited in chargeability and dischargeability (NO in S150), and the vehicle is travelling at intermediate or high speed (NO in S130), intermittently stopping engine 100 is nonetheless permitted. In other words, the FIG. 13 process may have Step S130 performed when Step S150 provides a decision of YES.

Thus the second embodiment in the second example allows the hybrid vehicle's vehicular speed to be further considered to further ensure an opportunity to intermittently operate engine 100 while avoiding a situation in which when engine 100 is intermittently stopped engine 100 can no longer subsequently restart. This further ensures an opportunity for the hybrid vehicle to have the intermittent engine operation for better fuel economy.

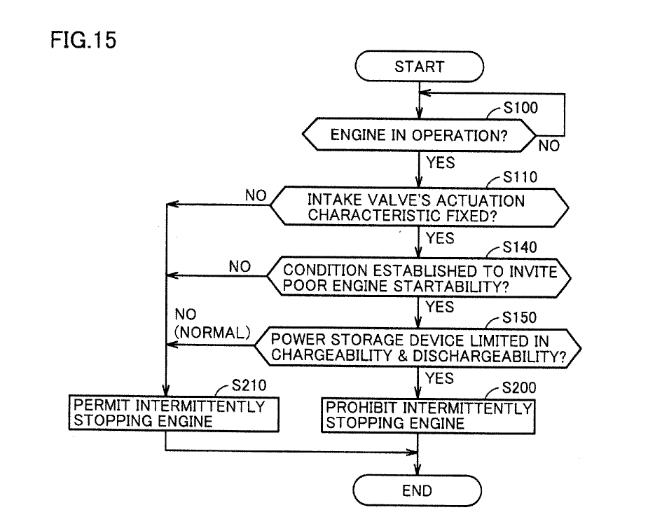

FIG. 15 is a flowchart of a process for controlling an intermittent engine operation in the hybrid vehicle according to the second embodiment in a third example. The FIG. 15 process can be performed by control device 200, similarly as done in the FIG. 11 process.

When FIG. 15 is compared with FIG. 11, control device 200 performs Steps S100 and S110, similarly as done in FIG. 11, and when intake valve 118 has the actuation characteristic fixed (YES in S110), control device 200 proceeds to Step S140 to determine whether a condition has been established to invite poor engine startability.

The condition inviting poor engine startability is established when engine 100 is per se in such a state that it is impaired in startability. For example, when engine 100 is at low temperature, engine 100 is in a cold state and thus provides less steady combustion, or engine 100 has increased friction, and accordingly, engine 100 is impaired in startability. If in such a condition power storage device B is limited in chargeability and dischargeability and an accordingly insufficient cranking torque is provided, and engine 100 is intermittently stopped, the engine may not be restarted.

For example, the engine's water coolant temperature Tw sensed by water temperature sensor 309 (see FIG. 3) can be compared with a prescribed reference value to determine whether the engine is in the cold state. Furthermore, the engine's lubricant oil temperature To sensed by oil temperature sensor 310 (see FIG. 3) can be compared with a prescribed reference value to determine whether the engine has large friction.

The fuel's property also affects engine 100 in startability. Representatively, when the fuel is heavy and thus evaporates less easily, engine 100 is reduced in startability. Whether the fuel is heavy or not can be determined from: a difference between a target rotational speed of engine 100 and an actual rotational speed of engine 100 that is caused when engine 100 is in operation and in a self-sustaining operation, as disclosed in Japanese Patent Laying-Open No. 2010-255943; or a difference between a target engine torque and an actual output torque that is caused when the engine is operated with a load imposed thereon. That is, the hybrid vehicle in the present embodiment also allows the rotational speed and/or torque of the engine in operation to be referred to and used in a known methodology to determine whether the fuel is heavy.

For example, in Step S140, the engine's coolant water temperature Tw, the engine's lubricant oil temperature To, and whether the fuel is heavy can be referred to to determine whether the condition inviting poor engine startability is established. Specifically, when Tw<T2 and To<T3 are established and the fuel is also heavy, it can be determined that the condition inviting poor engine startability has been established (YES in S140).

In contrast, when at least any one of Tw<T2, To<T3, and the condition that the fuel is heavy is unestablished, it can be determined that the condition inviting poor engine startability is not established (NO in S140). More specifically, when at least any one of Tw<T2 and To<T3 is established, the engine is in a warm state, and the control determines that the condition inviting poor engine startability is not established (NO in S140). Furthermore, when the control determines that the fuel is not heavy, the control also determines that the condition inviting poor engine startability is not established (NO in S140).

When the condition inviting poor engine startability is unestablished including engine 100 being in the warm state, and power storage device B only has electric power providing a small torque, engine 100 can still be intermittently stopped without failing to restart. Accordingly, when the condition inviting poor engine startability is not established (NO in S140), the control proceeds to Step S210 to permit intermittently stopping engine 100.

In contrast, when the condition inviting poor engine startability is established (YES in S140), control device 200 performs Step S150, similarly as done in FIG. 11. Thus when power storage device B is in a state ensuring a cranking torque, intermittently stopping engine 100 is permitted, whereas when it is difficult to ensure the cranking torque, intermittently stopping engine 100 is prohibited.

The FIG. 15 flowchart (or the second embodiment in the third example) is compared with the first embodiment as follows: when engine 100 is not impaired in startability (NO in S140), and power storage device B is limited in chargeability and dischargeability (YES in S150), intermittently stopping engine 100 is nonetheless permitted. Furthermore, when power storage device B is not limited in chargeability and dischargeability (NO in S150), and engine 100 is impaired in startability (YES in S140), intermittently stopping engine 100 is nonetheless permitted. In other words, the FIG. 15 process may have Step S140 performed when Step S150 provides a decision of YES.

Thus the second embodiment in the third example allows a state of engine 100 per se to be further considered to further ensure an opportunity to intermittently operate engine 100 while avoiding a situation in which when engine 100 is intermittently stopped engine 100 can no longer subsequently restart. This further ensures an opportunity for the hybrid vehicle to have the intermittent engine operation for better fuel economy.

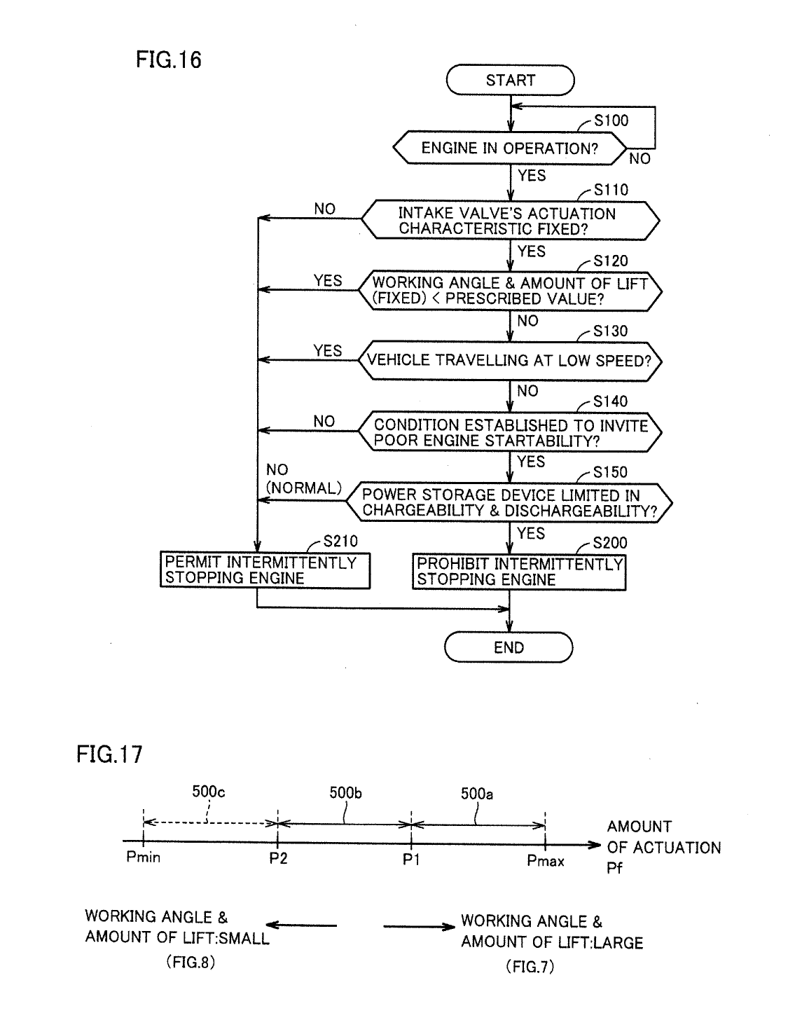

FIG. 16 is a flowchart of a process for controlling an intermittent engine operation in the hybrid vehicle according to the second embodiment in a fourth example. The FIG. 16 process can be performed by control device 200, similarly as done in the FIG. 11 process.

When FIG. 16 is compared with FIG. 11, control device 200 performs Steps S100 and S110, similarly as done in FIG. 11, and when intake valve 118 has the actuation characteristic fixed (YES in S110), control device 200 further performs Step S120 (see FIG. 12), Step S130 (see FIG. 13), and Step S140 (see FIG. 15) as described above. In other words, the second embodiment in the fourth example corresponds to controlling the intermittent engine operation, as described in the first embodiment, in combination with the second embodiment in the first to third examples.

As a result, the FIG. 16 flowchart (or the second embodiment in the fourth example) shows that when a condition for permitting the engine to intermittently stop, as described in the first embodiment, and in addition thereto at least any one of: the intake valve having a fixed actuation characteristic, i.e., being lifted in a smaller amount and worked by a smaller working angle than a prescribed value (YES in S120); hybrid vehicle 1 travelling at low vehicular speed (YES in S130); and engine 100 without poor startability (NO in S140) have been satisfied, intermittently stopping engine 100 is permitted.

Thus, a fixed actuation characteristic of intake valve 118 (a fixed amount of lifting it and a fixed working angle thereon), the hybrid vehicle's vehicular speed, and a state of engine 100 per se can further be considered in further ensuring an opportunity for the intermittent engine operation. As a result, the hybrid vehicle can achieve better fuel economy while avoiding a situation in which when engine 100 is intermittently stopped the engine can no longer subsequently restart.

Note that while the FIG. 16 flowchart shows a control process to perform all of Step S120 (see FIG. 12), Step S130 (see FIG. 13), and Step S140 (see FIG. 15) by way of example, only any two of these steps may be performed to combine the first embodiment and the second embodiment (in the first to third examples).

### Third Embodiment

In the first and second embodiments Steps S120-S150 are each performed by comparing a prescribed parameter with a reference value to determine whether intermittently stopping the engine should be permitted.

On the other hand, when intake valve 118 has the actuation characteristic fixed, whether intake valve 118 having the actuation characteristic fixed is lifted in a large or small amount and worked by a large or small working angle determines engine 100's startability, as has been described with reference to FIGS. 7 and 8. More specifically, when intake valve 118 is lifted in a small amount and worked by a small working angle, engine 100 can be intermittently stopped and then restarted even by a smaller cranking torque than when intake valve 118 is lifted in a large amount and worked by a large working angle.

Accordingly, it is preferable that when intake valve 118 is lifted in a small amount and worked by a small working angle, the Steps S120-S150 decisions be made to ensure more opportunities to intermittently stop the engine than when intake valve 118 is lifted in a large amount and worked by a large working angle. Accordingly, in the third embodiment will be described an intermittent engine operation controlled in such a manner that the reference values that have been described in the first and second embodiments to be applied in Steps S120-S150 are variable with an actuation characteristic of intake valve 118 (or an amount of lifting it and a working angle thereon) fixed.

FIG. 17 provides a representation of the intake valve's fixed actuation characteristic divided in controlling the intermittent engine operation according to the third embodiment.

With reference to FIG. 17, when intake valve 118 has the actuation characteristic fixed, the intake valve is lifted in an amount and worked by a working angle, and the current value of such amount and angle will hereinafter be collectively represented as an amount of actuation Pf. When intake valve 118 has the actuation characteristic fixed, amount of actuation Pf will be fixed in a range of a minimum value Pmin, which corresponds to the intake valve being lifted in a minimum amount and worked by a minimum working angle, to a maximum value Pmax, which corresponds to the intake valve being lifted in a maximum amount and worked by a maximum working angle. Accordingly, if Step S110 of FIG. 11 or the like indicates a decision of YES, then the current output of VVL position sensor 311 is referred to to compare amount of actuation Pf that is fixed with prescribed values P1 and P2.

When intake valve 118 is in a fixed state, it has amount of actuation Pf, which is divided into a large actuation range 500a (Pf>P1), an intermediate actuation range 500b (P2<Pf<P1), and a small actuation range 500c (Pf<P2). As has been described with reference to FIG. 7 and FIG. 8, of ranges 500a-500c, large actuation range 500a is accompanied by a decreased compression ratio and hence decreased engine startability, whereas small actuation range 500c is accompanied by an increased compression ratio and hence increased engine startability. Intermediate actuation range 500b allows better engine startability than large actuation range 500a.

Accordingly, the third embodiment provides an intermittent engine operation controlled with Steps S120-S150 performed with reference values varying stepwise with an amount of lifting intake valve 118 and a working angle on intake valve 118 that are fixed (i.e., amount of actuation Pf).

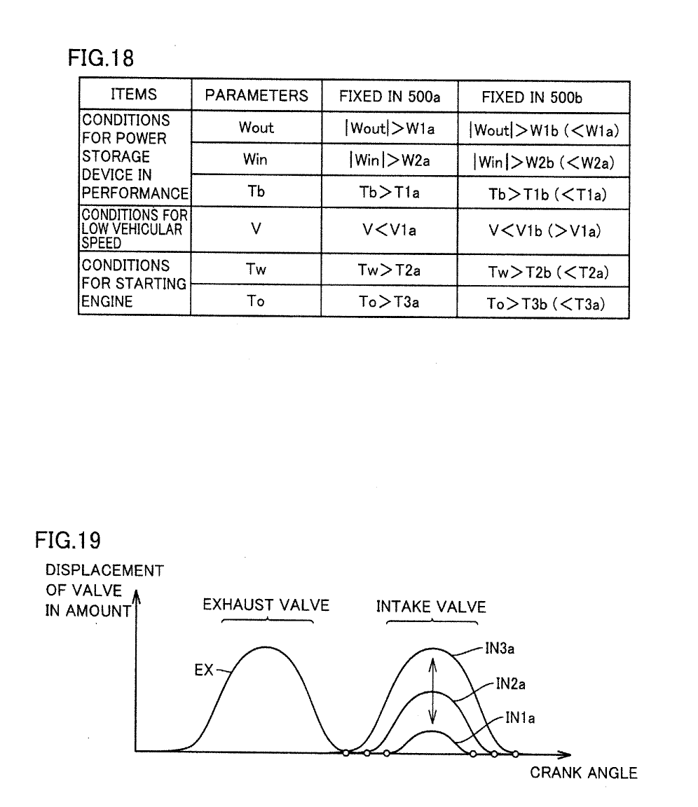

FIG. 18 is a table for describing an example of stepwise setting reference values used in controlling the intermittent engine operation according to the third embodiment.

With reference to FIG. 18, Step S150 (see FIGS. 11-13, 15 and 16) is performed to make a decision by referring to a state of power storage device B that is indicated by parameters represented as upper limit value Wout for electric power discharged, upper limit value Win for electric power charged, and temperature Tb, and when intake valve 118 has the actuation characteristic fixed such that the intake valve is lifted in a fixed amount and worked by a fixed working angle (or actuated in amount Pf) falling within large actuation range 500a, Step S150 is performed with reference to reference values set to W1a, W2a, and T1a, respectively. In that case, when at least any one of Wout>W1a (a first condition), |Win|>W2a (a second condition), and Tb>T1a (a third condition) has been established, it can be determined that power storage device B is not limited in chargeability and dischargeability (NO in S150).

In contrast, when intake valve 118 has the actuation characteristic fixed such that the intake valve is lifted in an amount and worked by a working angle (or actuated in amount Pf) falling within intermediate actuation range 500b, the reference values for upper limit value Wout for electric power discharged, upper limit value Win for electric power charged, and temperature Tb are set to W1b, W2b, and T1b, respectively. More specifically, for intermediate actuation range 500b, when at least any one of Wout>W2b (a first condition), |Win|>W2b (a second condition), and Tb>T1b (a third condition) has been established, it is determined that power storage device B is not limited in chargeability and dischargeability (NO in S150).

Note that these reference values are set to be W1b<W1a, W2b<W2a, and T1b<T1a. Accordingly, intermediate actuation range 500b allows Step S150, i.e., determining that intermittently stopping the engine is permitted when power storage device B is not limited in chargeability and dischargeability, to be performed such that intermittently stopping the engine is permitted under a looser condition than large actuation range 500a does.

Similarly, Step S130 (see FIGS. 13 and 16) is performed to make a decision using a parameter represented as vehicular speed V, and when intake valve 118 has the actuation characteristic fixed such that the intake valve is lifted in an amount and worked by a working angle (or actuated in amount Pf) falling within large actuation range 500a, Step S130 is performed with reference to a reference value set to V1a. In other words, for large actuation range 500a, when V<V1a is established, it is determined that the vehicle is travelling at low vehicular speed (YES in S130).

In contrast, when intake valve 118 has the actuation characteristic fixed such that the intake valve is lifted in an amount and worked by a working angle (or actuated in amount Pf) falling within intermediate actuation range 500b, Step S130 is performed with reference to vehicular speed V with a reference value of V1b set therefor. In other words, for intermediate actuation range 500b, when V<V1b is established, it is determined that the vehicle is travelling at low vehicular speed (YES in S130).

Reference values V1a and V1b have a relationship of V1b>V1a. Accordingly, intermediate actuation range 500b allows Step S130, i.e., determining that intermittently stopping the engine is permitted when the vehicle is travelling at low vehicular speed, to be performed such that intermittently stopping the engine is permitted under a looser condition than large actuation range 500a does.

Similarly, Step S140 (see FIGS. 15 and 16) is performed to make a decision using a parameter represented as the engine's coolant water temperature Tw and the engine's lubricant oil temperature To, and when intake valve 118 has the actuation characteristic fixed such that the intake valve is lifted in an amount and worked by a working angle (or actuated in amount Pf) falling within large actuation range 500a, Step S140 is performed with reference to reference values set to T2a and T3a, respectively. More specifically, for large actuation range 500a, when at least any one of Tw>T2a and To>T3a is established, the engine is in the warm state, and it is determined that the condition inviting poor engine startability is not established (NO in S140).

In contrast, when intake valve 118 has the actuation characteristic fixed such that the intake valve is lifted in an amount and worked by a working angle (or actuated in amount Pf) falling within intermediate actuation range 500b, the reference values for the engine's coolant water temperature Tw and the engine's lubricant oil temperature To are set to T2b and T3b, respectively. More specifically, for intermediate actuation range 500b, when at least any one of Tw>T2b and To>T3b is established, the engine is in the warm state, and it is determined that the condition inviting poor engine startability is not established (NO in S140).

Reference values T2a, T3a, T2b, T3b have a relationship of T2b<T2a and T3b<T3a. Accordingly, intermediate actuation range 500b allows Step S140, i.e., determining that intermittently stopping the engine is permitted when the engine is in the warm state (i.e., when the condition inviting poor engine startability is not established), to be performed such that intermittently stopping the engine is permitted under a looser condition than large actuation range 500a does.

Note that although not unshown in the figure, the result of whether the fuel is heavy, that is used in the Step S140 decision (see FIGS. 15 and 16), can also be set in a plurality of stages so that intermediate actuation range 500b allows intermittently stopping the engine to be permitted under a looser condition than large actuation range 500a does.

For example, if in the above described known technique a difference in rotational speed of engine 100 and that in torque thereof that are used to determine the fuel in heaviness are divided in a plurality or stages and thus used to determine how the fuel is heavy, then, Step S140, i.e., determining that intermittently stopping the engine is permitted when the fuel is not heavy (i.e., when the condition inviting poor engine startability is not established), can be performed such that intermittently stopping the engine is permitted up to a range of a higher degree of heaviness for intermediate actuation range 500b than for large actuation range 500a.

Note that in combination with the third embodiment providing Steps S130-S150 with reference values set in a plurality of stages, Step S120 (see FIGS. 12 and 16) may be arranged to permit intermittently stopping the engine when intake valve 118 has the actuation characteristic fixed such that the intake valve is lifted in an amount and worked by a working angle (or actuated in amount Pf) falling within small actuation range 500c.

Thus, for small actuation range 500c, the intermittent engine operation is permitted, whereas for intermediate actuation range 500b and large actuation range 500a, the intermittent engine operation is permitted based on at least one of the Steps S130-S150 decisions made with reference to the reference values switched as described above. In other words, when intake valve 118 has the actuation characteristic fixed such that the intake valve is lifted in an amount and worked by a working angle (or actuated in amount Pf) falling within intermediate actuation range 500b, intermittently stopping the engine can be permitted under a looser condition than when intake valve 118 is lifted in a larger amount and worked by a larger working angle than in intermediate actuation range 500b (i.e., than when intake valve 118 is lifted in an amount and worked by a working angle falling within large actuation range 500a).

Thus the third embodiment allows an intermittent engine operation controlled such that how the intake valve has its actuation characteristic fixed (i.e., in what fixed amount it is lifted and by what fixed angle it is worked) can be considered in alleviating a condition for permitting engine 100 to be intermittently stopped to further ensure an opportunity to intermittently stop engine 100 while avoiding a situation in which when engine 100 is intermittently stopped engine 100 can no longer subsequently restart. This allows hybrid vehicle 1 to achieve better fuel economy than the first and second embodiments.

VVL Device in Exemplary Variation

In the first to third embodiments intake valve 118 may be lifted in an amount and worked by a working angle which may vary continuously (or steplessly) as described above or may be set discretely (or stepwise).

FIG. 19 represents a relationship between the valve's displacement in amount and crank angle, as implemented by a VVL device 400A that can vary intake valve 118's actuation characteristic in three levels.

VVL device 400A is capable of varying the actuation characteristic to any one of first to third characteristics. The first characteristic is represented by a waveform IN1a. The second characteristic is represented by a waveform IN2a and corresponds to a larger amount of lift and a larger working angle than the first characteristic. The third characteristic is represented by a waveform IN3a and corresponds to a larger amount of lift and a larger working angle than the second characteristic.

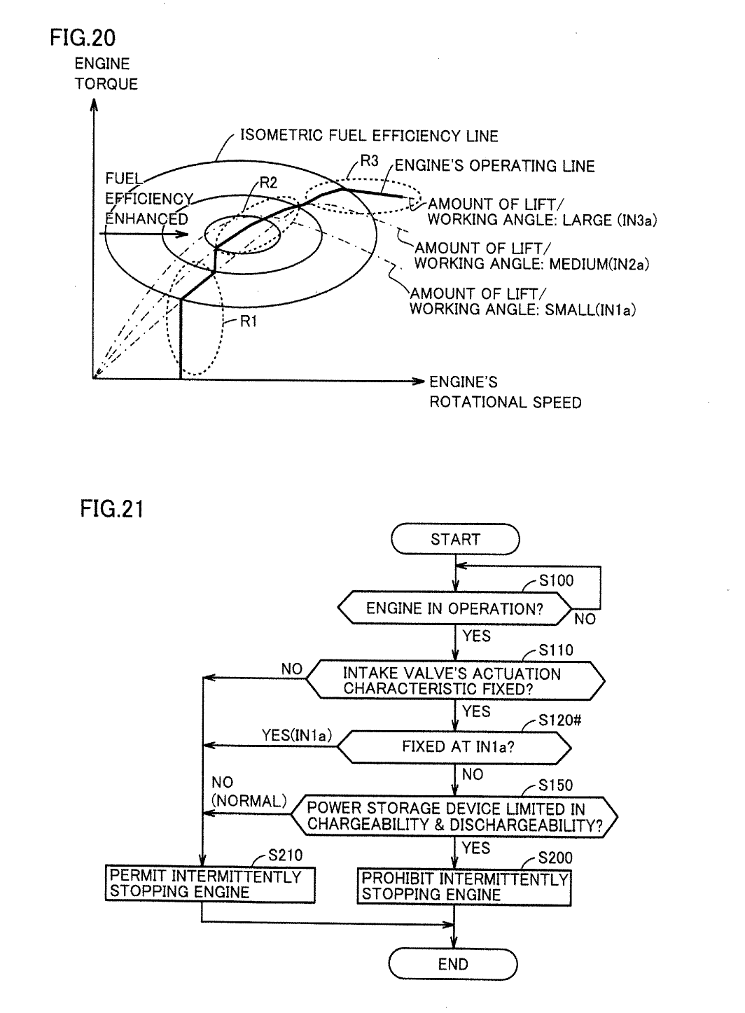

FIG. 20 shows an operating line of an engine including a VVL device having the actuation characteristic shown in FIG. 19.

In FIG. 20, the axis of abscissa represents the engine's rotational speed and the axis of ordinate represents engine torque. Note that in FIG. 20, alternate long and short dashed lines indicate torque characteristics corresponding to the first to third characteristics (IN1a-IN3a). Furthermore, in FIG. 20, a circle indicated by a solid line indicates an isometric fuel efficiency line. The isometric fuel efficiency line indicates connected points equal in fuel consumption, and a point closer to the center of the circle corresponds to more enhanced fuel efficiency. An engine 100A is basically operated on an engine operating line indicated in FIG. 20 by a solid line, for the sake of illustration.

Herein, a range R1 indicates a low rotational speed range, for which reducing a shock caused when the engine starts is important. Furthermore, exhaust gas recirculation (EGR) is ceased and the Atkinson cycle is applied for enhanced fuel efficiency. Accordingly, preferably, the third characteristic (IN3a) is selected as the actuation characteristic of intake valve 118 to provide an increased amount of lift and an increased working angle.

A range R2 indicates a medium rotational speed range, for which the EGR is applied to introduce exhaust gas in an increased amount for enhanced fuel efficiency. To do so, the second characteristic (IN2a) is selected as the actuation characteristic of intake valve 118 to provide an intermediate amount of lift and an intermediate working angle.

In other words, when intake valve 118 is lifted in a large amount and worked by a large working angle (i.e., the third characteristic is selected), enhancing fuel efficiency via the Atkinson cycle, rather than via the EGR, is prioritized. In contrast, when a medium amount of lift and a medium working angle are selected (i.e., the second characteristic is selected), enhancing fuel efficiency via the EGR, rather than via the Atkinson cycle, is prioritized.

A range R3 indicates a high rotational speed range, for which intake inertia is exploited to introduce a large amount of air into the cylinder to provide an increased actual compression ratio for better output performance. Accordingly, the third characteristic (IN3a) is selected as the actuation characteristic of intake valve 118 to provide an increased amount of lift and an increased working angle.

When engine 100A is operated in the low rotational speed range with a large load; engine 100A is started at cryogenic temperature; or a catalyst is warmed up, the first characteristic (IN1a) is selected as the actuation characteristic of intake valve 118 to provide a reduced amount of lift and a reduced working angle. Thus an amount of lift and a working angle are determined depending on how engine 100A is operated.

When the hybrid vehicle having VVL device 400A mounted therein to control intake valve 118 to have an actuation characteristic (or be lifted in an amount and worked by a working angle) has the actuation characteristic fixed for some reason in accordance with one of the first to third characteristics (IN1a-IN3a) under some conditions, the engine may be impaired in startability.

Accordingly, when the process described in the first embodiment with reference to FIG. 11 is applied, and the intake valve having an actuation characteristic (or lifted in an amount and worked by a working angle), as controlled by VVL device 400A, has the actuation characteristic fixed, intermittently stopping engine 100 is not unconditionally prohibited, and when power storage device B is not limited in chargeability and dischargeability and a cranking torque is ensured (NO in S150), intermittently stopping engine 100 is permitted.

Furthermore, when the process described in the second embodiment in the first example and shown in FIG. 12 is applied, the FIG. 21 flowchart can be followed to control the intermittent engine operation.

When FIG. 21 is compared with FIG. 12, control device 200 performs Steps S100 and S110 similarly as done in FIG. 12, and when intake valve 118 having the actuation characteristic controlled by VVL device 400A has the actuation characteristic fixed (YES in S110), control device 200 does not perform the FIG. 12 Step S120 and instead performs Step S120#.

Control device 200 in step S120# determines whether intake valve 118 has the actuation characteristic fixed in accordance with the first characteristic (IN1a). For the first characteristic (IN1a), intake valve 118 is lifted in a minimum amount and worked by a minimum working angle, and the engine's startability is ensured. Accordingly, when intake valve 118 has the actuation characteristic fixed in accordance with the first characteristic (IN1a) (YES in S120#), control device 200 proceeds to Step S210 to permit intermittently stopping engine 100.

In contrast, if intake valve 118 has the actuation characteristic fixed in accordance with the second characteristic (IN2a) or the third characteristic (IN3a) (NO in S120#), control device 200 performs Step S150, similarly as done in FIG. 11. Thus a hybrid vehicle having VVL device 400A applied thereto to allow the intake valve to have an actuation characteristic (or be lifted in an amount and worked by a working angle) controlled in three levels, can also be controlled similarly as shown in FIG. 12 (as described in the second embodiment in the first example).

Furthermore, the processes described in the second embodiment in the second and third examples and shown in FIG. 13 and FIG. 15 are also applicable to the hybrid vehicle having VVL device 400A applied thereto. When the intake valve having an actuation characteristic (or lifted in an amount and worked by a working angle), as controlled by VVL device 400A, has the actuation characteristic fixed, and in that condition, the vehicle is travelling at low speed (YES in S130) and/or the condition inviting poor engine startability is not established (NO in S140), intermittently stopping engine 100 is permitted.

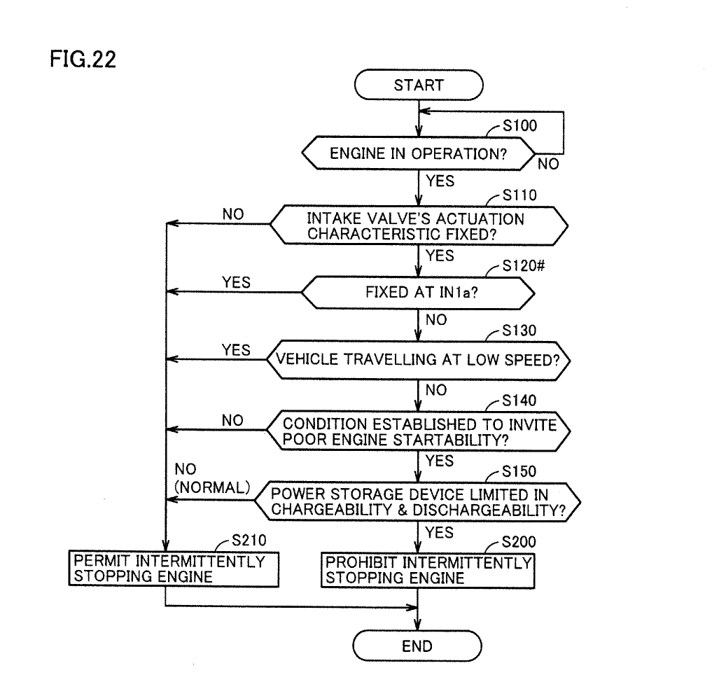

Furthermore, when the process described in the second embodiment in the fourth example and shown in FIG. 16 is applied to the hybrid vehicle having VVL device 400A applied thereto, the FIG. 22 flowchart can be followed to control the intermittent engine operation.

When FIG. 22 is compared with FIG. 16, control device 200 replaces the FIG. 16 Step S120 with Step S120# similar to that of FIG. 21. The other steps are similar to those of FIG. 16, and accordingly, will not be described repeatedly.

The hybrid vehicle having VVL device 400A applied thereto can thus also be permitted to intermittently stop engine 100 when a condition for permitting intermittently stopping the engine with reference to a state of power storage device B, as described in the first embodiment, and in addition thereto at least any one of: intake valve 118 having an actuation characteristic fixed in accordance with the first characteristic (IN1a) (YES in S120#); hybrid vehicle 1 travelling at low vehicular speed (YES in S130); and engine 100 without poor startability (NO in S140) have been satisfied. The FIG. 22 flowchart may also be modified to perform only any two of Step S120# (see FIG. 22), Step S130 (see FIG. 13), and Step S140 (see FIG. 15).

This allows the hybrid vehicle having VVL device 400A applied thereto to also have the engine intermittently operated as controlled as described in the first or second embodiment to achieve better fuel economy while avoiding a situation in which when engine 100 is intermittently stopped the engine can no longer subsequently restart.

Furthermore, the hybrid vehicle having VVL device 400A applied thereto can also be provided in a combination of the first or second embodiment and the third embodiment to allow Steps S130-S150 to be performed with the reference values set in a plurality of stages.

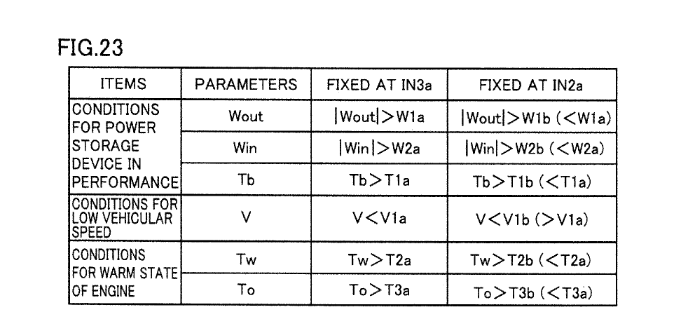

FIG. 23 is a table showing an example of setting reference values stepwise, as applied when the third embodiment is applied to the hybrid vehicle having VVL device 400A applied thereto.

Comparing FIG. 23 with FIG. 18, when intake valve 118 having an actuation characteristic controlled by VVL device 400A has the actuation characteristic fixed in accordance with the third characteristic (IN3a), a reference value is set that is similar to that for large actuation range 500a as shown in FIG. 18.

Furthermore, when intake valve 118 having the actuation characteristic controlled by VVL device 400A has the actuation characteristic fixed in accordance with the second characteristic (IN2a), a reference value is set that is similar to that for intermediate actuation range 500b as shown in FIG. 18.

Thus, when intake valve 118 has the actuation characteristic fixed in accordance with the second characteristic (IN2a), intermittently stopping the engine can be permitted under a looser condition than when intake valve 118 has the actuation characteristic fixed in accordance with the third characteristic (IN3a). Note that when whether the fuel is heavy is referred to, intermittently stopping the engine can be permitted up to a range of a higher degree of heaviness when intake valve 118 has the actuation characteristic fixed in accordance with the second characteristic (IN2a) than when intake valve 118 has the actuation characteristic fixed in accordance with the third characteristic (IN3a).

Furthermore, when Step S120# (see FIG. 21 and FIG. 22) is combined, and intake valve 118 has the actuation characteristic fixed in accordance with the first characteristic (IN1a), intermittently stopping the engine is permitted, whereas when intake valve 118 has the actuation characteristic fixed in accordance with the second or third characteristic (IN2a or IN3a), the intermittent engine operation can be permitted based on at least one of the Steps S130-S150 decisions made with reference to the reference values switched as shown in FIG. 23.

The hybrid vehicle having VVL device 400A applied thereto to allow intake valve 118 to have an actuation characteristic switched in three levels can thus also have the engine intermittently operated as described in the first to third embodiments to ensure an opportunity to intermittently stop engine 100 while avoiding a situation in which when engine 100 is intermittently stopped engine 100 can no longer subsequently restart. The hybrid vehicle can thus be improved in fuel economy.

Note that when VVL device 400A is applied, intake valve 118 is lifted in an amount and worked by a working angle that are limited to three levels, and engine 100's operation state can be controlled via a control parameter adapted in a period of time shorter than required when intake valve 118 is lifted in a steplessly varying amount and worked by a steplessly varying working angle. Furthermore, a torque that an actuator requires to vary the amount of lifting intake valve 118 and the working angle on intake valve 118 can be reduced and the actuator can thus be reduced in size and weight. The actuator can thus also be produced at a reduced cost.

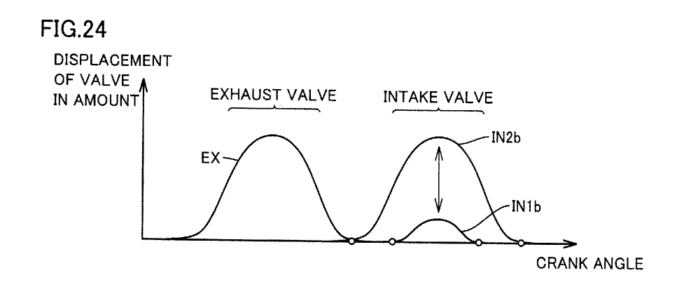

FIG. 24 represents a relationship between the valve's displacement in amount and crank angle, as implemented by a VVL device 400B that can vary intake valve 118's actuation characteristic in two levels. VVL device 400B is capable of varying the actuation characteristic to a first or second characteristic. The first characteristic is represented by a waveform IN1b. The second characteristic is represented by a waveform IN2b and corresponds to a larger amount of lift and a larger working angle than the first characteristic.

When the hybrid vehicle having VVL device 400B mounted therein to control intake valve 118 to have an actuation characteristic (or be lifted in an amount and worked by a working angle) has the actuation characteristic fixed for some reason in accordance with one of the first and second characteristics (IN1a and IN2a), the engine may be impaired in startability.

Accordingly, when the process described in the first embodiment with reference to FIG. 11 is applied, and the intake valve having an actuation characteristic (or lifted in an amount and worked by a working angle), as controlled by VVL device 400B, has the actuation characteristic fixed, intermittently stopping engine 100 is not unconditionally prohibited, and when power storage device B is not limited in chargeability and dischargeability and a cranking torque is ensured (NO in S150), intermittently stopping engine 100 is permitted.

Furthermore, when the process described in the second embodiment in the first example and shown in FIG. 12 is applied, the FIG. 21 flowchart can be followed to control the intermittent engine operation. In other words, control device 200 performs Step S120#, similarly as done in FIG. 21, and when intake valve 118 having the actuation characteristic controlled by VVL device 400B has the actuation characteristic fixed in accordance with the first characteristic (IN1a) (YES in S120#), the control proceeds to Step S210 to permit intermittently stopping engine 100.

In contrast, if intake valve 118 has the actuation characteristic fixed in accordance with the second characteristic (IN2a) (NO in S120#), control device 200 performs Step S150, similarly as done in FIG. 21.

Thus a hybrid vehicle having VVL device 400B applied thereto to allow the intake valve to have an actuation characteristic (or be lifted in an amount and worked by a working angle) controlled in two levels, can also have the engine intermittently controlled according to the second embodiment in the first example.

Furthermore, the processes described in the second embodiment in the second and third examples and shown in FIG. 13 and FIG. 15 are also applicable to the hybrid vehicle having VVL device 400B applied thereto. When the intake valve having an actuation characteristic (or lifted in an amount and worked by a working angle), as controlled by VVL device 400B, has the actuation characteristic fixed, and in that condition, the vehicle is travelling at low speed (YES in S130) and/or the condition inviting poor engine startability is not established (NO in S140), intermittently stopping engine 100 is permitted.

Furthermore, when the hybrid vehicle having VVL device 400B applied thereto is controlled in the process described in the second embodiment in the fourth example (see FIG. 16), the hybrid vehicle can also have the engine controlled to be intermittently operated in accordance with the FIG. 22 flowchart including Step S120#.

In other words, the hybrid vehicle having VVL device 400B applied thereto can also be permitted to intermittently stop engine 100 when a condition for permitting the engine to be intermittently stopped with reference to a state of power storage device B, as described in the first embodiment, and in addition thereto at least any one of: intake valve 118 having an actuation characteristic fixed in accordance with the first characteristic (IN1a) (YES in S120#); hybrid vehicle 1 travelling at low vehicular speed (YES in S130); and engine 100 without poor startability (NO in S140) have been satisfied. Note that the FIG. 22 flowchart may also be modified to perform only any two of Step S120# (see FIG. 22), Step S130 (see FIG. 13), and Step S140 (see FIG. 15).

This allows the hybrid vehicle having VVL device 400B applied thereto to also have the engine intermittently operated as controlled as described in the first or second embodiment to achieve better fuel economy while avoiding a situation in which when engine 100 is intermittently stopped the engine can no longer subsequently restart.

Furthermore, the third embodiment can further be combined when the intermittent engine operation is controlled as modified to perform at least any one of Step S130 (see FIGS. 13 and 22), Step S140 (see FIGS. 15 and 22), and Step S150 (see FIGS. 11, 22 and the like) excluding Step S120#. More specifically, when intake valve 118 having the actuation characteristic controlled by VVL device 400B has the actuation characteristic fixed in accordance with the second characteristic (IN2a), a reference value is set that is similar to that for large actuation range 500a as shown in FIG. 18, whereas when intake valve 118 has the actuation characteristic fixed in accordance with the first characteristic (IN1a), a reference value is set that is similar to that for intermediate actuation range 500b as shown in FIG. 18.

The hybrid vehicle having VVL device 400B applied thereto can thus also have the engine to be intermittently operated as described in the first to third embodiments to ensure an opportunity to intermittently stop engine 100 while avoiding a situation in which when engine 100 is intermittently stopped engine 100 can no longer subsequently restart. This allows hybrid vehicle 1 to be improved in fuel economy. It should be noted, however, that VVL device 400B only allows the intake valve to have an actuation characteristic (or be lifted in an amount and worked by a working angle) varying in two levels, and controlling the intermittent engine operation with Step S120# included (i.e., the second embodiment) cannot be combined with the third embodiment.

VVL device 400B allows intake valve 118 to be lifted in an amount and worked by a working angle that are limited to two actuation characteristics, and engine 100's operation state can be controlled via a control parameter adapted in a further shorter period of time. Furthermore, the actuator is allowed to have a simpler configuration. Note that intake valve 118 may not be lifted in an amount or worked by a working angle that are limited to an actuation characteristic varying between two or three levels, and intake valve 118 may be lifted in an amount and worked by a working angle with an actuation characteristic varying between four or more levels.

While the above embodiments and their exemplary variations have been described for a case with the amount of lifting intake valve 118 and the working angle on intake valve 118 both controlled as an actuation characteristic thereof, the present invention is also applicable to a configuration with the amount of lifting intake valve 118 alone controllable (or variable) as an actuation characteristic thereof and a configuration with the working angle on intake valve 118 alone controllable (or variable) as an actuation characteristic thereof. A configuration that can control (or vary) either the amount of lifting intake valve 118 or the working angle on intake valve 118 can also be as effective as that which can vary both the amount of lifting intake valve 118 and the working angle on intake valve 118. Note that the configuration that can control (or vary) either the amount of lifting intake valve 118 or the working angle on intake valve 118 can be implemented via well known technology.

When either an amount of lifting intake valve 118 or a working angle on intake valve 118 is controllable (or variable), arranging VVL position sensor 311 to sense either the amount or the angle and determining for either the amount or the angle what is determined for both the amount and the angle in the embodiments allow the engine to be similarly, intermittently controlled.

Thus, the present invention is applicable to a hybrid vehicle including a variable valve actuation device allowing intake valve 118 to have an actuation characteristic that is represented by an amount of lifting intake valve 118 and/or a working angle on intake valve 118, varying continuously (or steplessly) or discretely (or stepwise).

While the above embodiments have been described in connection with a series/parallel type hybrid vehicle capable of splitting the motive power of engine 100 by power split device 4 and thus transmitting the split motive power to driving wheel 6 and motor generators MG1 and MG2, the present invention is also applicable to hybrid vehicles of other types. More specifically, the present invention is for example also applicable to a so-called series type hybrid vehicle that uses engine 100 only to drive motor generator MG1 and generates vehicular driving force only by motor generator MG2, a hybrid vehicle recovering only regenerated energy of kinetic energy that is generated by engine 100 as electrical energy, a motor-assisted hybrid vehicle using an engine as a main driving force source and assisted by a motor as required, and the like. Furthermore, the present invention is also applicable to a hybrid vehicle which allows a motor to be disconnected and travels by the driving force of the engine alone. In other words, any hybrid vehicle including an internal combustion engine having a variable valve actuation device for varying an actuation characteristic of an intake valve can benefit from the idea of the present invention that when the actuation characteristic, controlled by the variable valve actuation device, is fixed, intermittently stopping the engine is not unconditionally prohibited and is instead permitted depending on the vehicle's status.

Note that, in the above, engine 100 corresponds in the present invention to one embodiment of an internal combustion engine, motor generator MG1 corresponds in the present invention to one embodiment of a rotating electric machine, and VVL devices 400, 400A, 400B correspond in the present invention to one embodiment of a variable valve actuation device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A hybrid vehicle comprising:
an internal combustion engine having a variable valve actuation device configured to control an actuation characteristic of an intake valve, said actuation characteristic being at least one of an amount of lifting said intake valve and a working angle on said intake valve;
a detector configured to detect said actuation characteristic controlled by said variable valve actuation device;
a rotating electric machine configured to be capable of starting said internal combustion engine;
a power storage device configured to store electric power therein for driving said rotating electric machine; and
a control device configured to receive an output of said detector and also control said internal combustion engine,
when said detector detects that said actuation characteristic is fixed, said control device permits intermittently stopping said internal combustion engine, based on a state of said power storage device associated with a cranking torque that said rotating electric machine can output.

2. The hybrid vehicle according to claim 1, wherein when said actuation characteristic is fixed with at least one of said amount of lifting said intake valve and said working angle on said intake valve larger than a prescribed value, said control device permits intermittently stopping said internal combustion engine, based on said state of said power storage device.

3. The hybrid vehicle according to claim 1, wherein said control device permits intermittently stopping said internal combustion engine in response to at least any one of first to third conditions being established, said first condition being that said power storage device has an upper limit value for electric power charged having an absolute value larger than a first prescribed electric power value, said second condition being that said power storage device has an upper limit value for electric power discharged having an absolute value larger than a second prescribed electric power value, said third condition being that said power storage device is higher in temperature than a reference temperature.

4. The hybrid vehicle according to claim 2, wherein said control device permits intermittently stopping said internal combustion engine when said actuation characteristic is fixed with said at least one of said amount of lifting said intake valve and said working angle on said intake valve smaller than said prescribed value.

5. The hybrid vehicle according to claim 1, wherein:
said variable valve actuation device is configured to be capable of switching said actuation characteristic of said intake valve to any one of a first characteristic, a second characteristic allowing at least one of said amount of lifting said intake valve and said working angle on said intake valve to be larger than when said actuation characteristic is said first characteristic, and a third characteristic allowing at least one of said amount of lifting said intake valve and said working angle on said intake valve to be larger than when said actuation characteristic is said second characteristic; and
when said detector detects that said actuation characteristic is fixed in accordance with any one of said first to third characteristics, said control device permits intermittently stopping said internal combustion engine, based on said state of said power storage device.

6. The hybrid vehicle according to claim 5, wherein when said detector detects that said actuation characteristic is fixed in accordance with any one of said second and third characteristics, said control device permits intermittently stopping said internal combustion engine, based on said state of said power storage device.

7. The hybrid vehicle according to claim 5, wherein said control device permits intermittently stopping said internal combustion engine in response to at least any one of first to third conditions being established, said first condition being that said power storage device has an upper limit value for electric power charged having an absolute value larger than a first prescribed electric power value, said second condition being that said power storage device has an upper limit value for electric power discharged having an absolute value larger than a second prescribed electric power value, said third condition being that said power storage device is higher in temperature than a reference temperature.

8. The hybrid vehicle according to claim 7, wherein when said actuation characteristic is fixed in accordance with said second characteristic, at least one of said first prescribed electric power value, said second prescribed electric power value, and said reference temperature is set to be lower than when said actuation characteristic is fixed in accordance with said third characteristic.

9. The hybrid vehicle according to claim 7, wherein when said detector detects that said actuation characteristic is fixed in accordance with said first characteristic, said control device permits intermittently stopping said internal combustion engine.

10. The hybrid vehicle according to claim 1, wherein:
said variable valve actuation device is configured to be capable of switching said actuation characteristic of said intake valve to any one of a first characteristic and a second characteristic allowing at least one of said amount of lifting said intake valve and said working angle on said intake valve to be larger than when said actuation characteristic is said first characteristic; and
when said detector detects that said actuation characteristic is fixed in accordance with any one of said first and second characteristics, said control device permits intermittently stopping said internal combustion engine, based on said state of said power storage device.

11. The hybrid vehicle according to claim 10, wherein when said detector detects that said actuation characteristic is fixed in accordance with said second characteristic, said control device refers to said state of said power storage device to permit intermittently stopping said internal combustion engine.

12. The hybrid vehicle according to claim 9, wherein said control device permits intermittently stopping said internal combustion engine in response to at least any one of first to third conditions being established, said first condition being that said power storage device has an upper limit value for electric power charged having an absolute value larger than a first prescribed electric power value, said second condition being that said power storage device has an upper limit value for electric power discharged having an absolute value larger than a second prescribed electric power value, said third condition being that said power storage device is higher in temperature than a reference temperature.

13. The hybrid vehicle according to claim 11, wherein when said detector detects that said actuation characteristic is fixed in accordance with said first characteristic, said control device permits intermittently stopping said internal combustion engine.

14. The hybrid vehicle according to claim 3, wherein said control device prohibits intermittently stopping said internal combustion engine when none of said first to third conditions is established.

15. The hybrid vehicle according to claim 3, wherein when none of said first to third conditions is established, and the hybrid vehicle has a vehicular speed equal to or higher than a prescribed speed and a prescribed condition indicating that said internal combustion engine is impaired in startability has also been established, said control device prohibits intermittently stopping said internal combustion engine.

16. The hybrid vehicle according to claim 1, wherein when said detector detects that said actuation characteristic is fixed, and the hybrid vehicle has a vehicular speed lower then a prescribed speed, said control device also permits intermittently stopping said internal combustion engine.

17. The hybrid vehicle according to claim 1, wherein when said detector detects that said actuation characteristic is fixed, and said internal combustion engine is in a warm state, said control device also permits intermittently stopping said internal combustion engine.

18. The hybrid vehicle according to claim 1, wherein when said at least one of said amount of lifting said intake valve and said working angle on said intake valve is fixed within a prescribed range, said control device allows intermittently stopping said internal combustion engine to be permitted under a looser condition than when said at least one of said amount of lifting said intake valve and said working angle on said intake valve is fixed to be larger than said prescribed range.

19. The hybrid vehicle according to claim 1, wherein said rotating electric machine is mechanically coupled with both an output shaft of said internal combustion engine and a drive shaft of the hybrid vehicle at least via a motive power transmission gear.
